(19) United States
(12) Patent Application Publication
(10) Pub. No.: US 2022/0202645 A1
(43) Pub. Date: Jun. 30, 2022

(54) HEAD UNITS FOR A TREATMENT DEVICE

(71) Applicants: Joseph ROGOZINSKI, Ramat Gan (IL); Itzhak FRIEDMAN, Petach Tikva (IL); SImon ROTENSHTEIN, Rosh Ha'ain (IL)

(72) Inventors: Joseph ROGOZINSKI, Ramat Gan (IL); Itzhak FRIEDMAN, Petach Tikva (IL); SImon ROTENSHTEIN, Rosh Ha'ain (IL)

(21) Appl. No.: 17/695,905

(22) Filed: Mar. 16, 2022

Related U.S. Application Data
(63) Continuation-in-part of application No. PCT/IB2020/058599, filed on Sep. 16, 2019.
(60) Provisional application No. 62/900,685, filed on Sep. 16, 2019.

(51) Int. Cl. A61H 23/02

(52) U.S. Cl. CPC A61H 23/02; A61H 2023/002

(57) ABSTRACT

A myofascial massager for mechanical treatment of a treatment location in a human subject's body. The massager includes an actuator which operates in a cyclical linear amplitude field for a few millimeters and at a frequency range from some Hz to a few dozen Hz. A head unit connected to the actuator includes a first portion having a higher rigidity, and a membrane having a second lower rigidity, which membrane comes into contact with the treatment location.

### FIELD OF THE INVENTION

The present invention relates, in general, to the field of treatment and/or physical therapy or massage therapy, and specifically to head units for a device based on an actuator using linear movement, which head unit contains a portion formed of a flexible material that engages a subject's body.

### SUMMARY OF THE INVENTION

The present invention relates to head units for use with external devices based on an actuator using linear movement. Each of the head units includes at least one portion formed of a flexible material, which portion engages the subject's body.

In accordance with an embodiment of the present invention there is provide a head unit, including:

a first portion arranged about a main longitudinal axis of the head unit, the first portion having a first rigidity, the first portion including a first connection region connectable to an external device; and

a second portion having a second rigidity, smaller than the first rigidity, the second portion including a flexible and elastic membrane, the membrane including:
a first protrusion extending outwardly from the membrane away from the first portion and including a first extreme point associated with a first virtual tangential plane; and
a second protrusion extending outwardly from the membrane away from the first portion and including a second extreme point associated with a second virtual tangential plane,

wherein the head unit can be operated by the external device in a periodic manner characterized by at least one amplitude and at least one frequency, and

wherein the first and second protrusions are adapted, during operation of the head unit, to engage and apply force to an external surface in a graded manner.

In some embodiments, a first height of the first protrusion is different from a second height of the second protrusion, and the graded manner of engagement and application of force is at least partially a result of the different first and second heights.

In some embodiments, the membrane is an equidistant membrane such that a first height of the first protrusion is equal to a second height of the second protrusion, and the graded manner of engagement and application of force is at least partially a result of the external surface being a graded external surface.

In some embodiments, the membrane is an equidistant membrane such that a first height of the first protrusion is equal to a second height of the second protrusion, and the graded manner of engagement and application of force is at least partially a result of angled application of force.

In some embodiments, the first protrusion is a central protrusion centered adjacent the main longitudinal axis, and the second protrusion is circumferential about the first protrusion.

In some embodiments, the first protrusion is a first circumferential protrusion disposed adjacent the main longitudinal axis, and the second protrusion is circumferential about the first circumferential protrusion. In some such embodiments, the first circumferential protrusion forms a complete circumference and has a fixed height along its entire circumference. In some other such embodiments, the first circumferential protrusion forms an incomplete circumference and has at least one segment having the first height and at least another segment having a third height, lower than the first height.

In some embodiments, the second circumferential protrusion forms a complete circumference and has a fixed height along its entire circumference. In some other embodiments, the second circumferential protrusion forms an incomplete circumference and has at least one segment having the second height and at least one other segment having a fourth height, lower than the second height.

In some embodiments, the membrane is formed of a viscoelastic material. In other embodiments, the membrane is formed of an auxetic material. In yet other embodiments, the membrane is formed of polyurethane.

In some embodiments, the membrane is separate from the first portion and is attachable thereto. In other embodiments, the first portion and the membrane are integrally formed of a single material.

In some embodiments, during application of an increasing force pushing the head unit onto the external surface, when the external surface is a flexible external surface, a contact area of the membrane with the external surface increases, resulting in a decrease of a distance between the first and second protrusions, thereby causing pinching and release of the flexible external surface between the first and second protrusions in a direction perpendicular to the main longitudinal axis.

In some embodiments, during application of force to the membrane against a rigid external surface, a configuration of a surface of the membrane is determined by a contour of the rigid external surface. In some embodiments, during application of force to the membrane and a flexible external surface, a configuration of a surface of the membrane is determined by a flexibility of the membrane and a flexibility of the flexible external surface.

In some embodiments, the membrane is asymmetrical relative to the main longitudinal axis, and has a first side having a first radius and a second side having a second radius, the second radius being larger than the first radius.

In some embodiments, the membrane has a first longitudinal dimension and a second dimension, the first longitudinal dimension being greater than the second dimension and being in a direction perpendicular to the main longitudinal axis, and the membrane is arched in a direction of the second dimension.

In some embodiments, the head unit further includes a fluid insertion portal disposed in the first connection area, the portal having an open operative orientation and a sealed operative orientation.

In some embodiments, the head unit further includes a reinforcing ring surrounding the first connection region.

In some embodiments, when the membrane is pressed against a planar external surface, initially an outer circumference of the membrane engages with the planar external surface, and subsequently inner regions of the membrane contact the planar external surface.

In some embodiments the head unit further includes a plurality of additional protrusions disposed between the first portion and the second portion of the head unit, which additional protrusions form local peripheral sealing areas at increased force. In some such embodiments, the head unit further includes at least one sealing ring adapted to increase force in the sealing areas. In some embodiments, the at least one sealing ring includes clamps adapted to engage the first portion at the sealing areas.

In accordance with another embodiment of the disclosed technology, there is provided a system including at least two head units according to any embodiment(s) disclosed hereinabove, the head units being mechanically connected to a single intermediate base, single the intermediate base including a connector adapted for connection to an actuator.

In some embodiments, an angle of at least one of the at least two head units, relative to at least a portion of the intermediate base, is adjustable.

In some embodiments, the at least two head units are fluidly connected, such that fluid can pass between cavities of the at least two head units.

In some embodiments, the intermediate base is springy.

In accordance with yet another embodiment of the disclosed technology, there is provided a method for providing treatment to a treatment surface, the method including:

attaching a head unit according to any embodiment(s) disclosed hereinabove or a system according to any embodiment(s) disclosed hereinabove, to an external device functioning as an actuator;

engaging the membrane of the head unit with the treatment surface, in a graded manner; and

operating the actuator such that the actuator causes percussion of the membrane against the treatment surface, wherein the application of force is periodic and is characterized by at least one amplitude and at least one frequency.

In some embodiments, the treatment surface is equivalent in structure to a surface of the human body. In some other embodiments, the treatment surface is a surface of the human body.

In accordance with a further embodiment of the disclosed technology, there is provided a head unit, connectable to an external device, the external device including an actuator suitable for operating the head unit, the head unit including:

a first portion arranged about a main longitudinal axis of the head unit, the first portion having a first rigidity, the first portion including a first connection region reversibly connectable to the external device; and

a second portion having a second rigidity, smaller than the first rigidity, the second portion including a flexible and elastic membrane, the membrane including:
a first protrusion extending outwardly from the membrane away from the first portion and including a first extreme point associated with a first virtual tangential plane; and
a second protrusion extending outwardly from the membrane away from the first portion and including a second extreme point associated with a second virtual tangential plane; and

an intermediate portion, fixedly attached to the first portion and disposed between the first portion and the second portion, the intermediate portion having a third rigidity, different from the first rigidity and from the second rigidity,

wherein a perimeter of the membrane is attached to the intermediate portion along a perimeter of the intermediate portion,

wherein the head unit can be operated by the actuator of the external device in a periodic manner characterized by at least one amplitude and at least one frequency, and

wherein the first and second protrusions are adapted, during operation of the head unit, to engage and apply force to an external surface in a graded manner.

In some embodiments, membrane is connected to the first portion only by the perimeter of the membrane.

In some embodiments, a first height of the first protrusion is different from a second height of the second protrusion, and wherein the graded manner of engagement and application of force is at least partially a result of the different first and second heights.

In some embodiments, the first protrusion is centered about the main longitudinal axis, and the second protrusion is circumferential about the first protrusion.

In some embodiments, the membrane is formed of a viscoelastic material or of an auxetic material.

In some embodiments, the membrane is separate from the first portion and the intermediate portion, and is reversibly attachable to the intermediate portion along the perimeter.

In some embodiments, wherein the first portion, the intermediate portion, and the membrane are integrally formed of a single material.

In some embodiments, during application of an increasing force pushing the head unit onto the external surface, when the external surface is a flexible external surface, a contact area of the membrane with the external surface increases, resulting in a decrease of a distance between the first and second protrusions, thereby causing pinching and release of the flexible external surface between the first and second protrusions in a direction perpendicular to the main longitudinal axis.

In some embodiments, during application of force to the membrane against a rigid external surface, a configuration of a surface of the membrane is determined by at least one of a contour of the rigid external surface, a flexibility of the membrane, and a flexibility of the rigid external surface.

In some embodiments, the membrane is asymmetrical relative to the main longitudinal axis, and has a first side having a first radius and a second side having a second radius, the second radius being larger than the first radius.

In some embodiments, the head unit further includes a fluid insertion portal disposed in the first portion or in the intermediate portion, the portal having an open operative orientation and a sealed operative orientation.

In some embodiments, the head unit further includes a reinforcing ring surrounding the first connection region.

In some embodiments, in a rest state of the head unit and during operation of the head unit, there is a fluid filled gap between the membrane and the first portion, along the main longitudinal axis.

In some embodiments, the third rigidity is smaller than the second rigidity. In other embodiments, the third rigidity is greater than the second rigidity, and smaller than the first rigidity.

In some embodiments, force of the actuator is transferred to the membrane only via the perimeter of the membrane.

In some embodiments, force of the actuator is transferred axially to the perimeter of the membrane, and within the membrane, the force is transferred from one protrusion to the next protrusion, in a radially inward direction.

In some embodiments, the head unit being devoid of an internal actuator.

In accordance with yet another embodiment of the disclosed technology, there is provided a system including at least two head units as described herein, the head units being mechanically connected to a single intermediate base, the single intermediate base including a connector adapted for connection to the external device.

In accordance with another embodiment of the disclosed technology, there is provided a method for providing treatment to a treatment surface, the method including:

attaching a head unit or a system as described herein to an external device functioning as an actuator;

engaging the membrane of the head unit with the treatment surface, in a graded manner; and

operating the actuator such that the actuator causes percussion of the membrane against the treatment surface, wherein the application of force is periodic and is characterized by at least one amplitude and at least one frequency.

### Definitions

This disclosure should be interpreted according to the definitions below.

In case of a contradiction between the definitions in this Definitions section and other sections of this disclosure, this section should prevail.

In case of a contradiction between the definitions in this section and a definition or a description in any other document, including in another document included in this disclosure by reference, this section should prevail, even if the definition or the description in the other document is commonly accepted by a person of ordinary skill in the art.

Cardinal directions are defined relative to the orientation of a head unit, during normal use with the membrane applying force in a vertical direction to the horizontal surface of a table. Thus, the “bottom” of the head unit is the portion closest to the horizontal surface of the table during such use, and adjacent the membrane of the head unit, and “top” of the head unit is the portion farthest from the horizontal surface of the table during such use, and adjacent the connection to an external device.

The term “graded” is defined as relating mainly to deformation of surfaces, to changes in the size of engagement areas between a membrane and a contact surface, and/or to motion, caused by application of force to a head unit. The term graded in the context of the present application relates to something that is not continuous, but rather occurs in multiple bursts.

Graded engagement of a membrane and a surface may occur when the membrane of a head unit includes multiple protrusions having different heights, relative to each other or relative to an upper plane of the head unit. In this case, the graded engagement occurs by initial engagement of one of the protrusions, and only subsequent engagement of another of the protrusions, resulting in a non-continuous engagement between the membrane and the surface.

As another example, a graph would be considered graded if the plot of the graph forms the shape of steps, rather than a continuous incline.

The term “amplitude” is defined as commonly used in physics, and relates to the maximal distance of the graph from a baseline, such as a zero line. For example, in a sinusoidal graph, the maximal travel, or variance, of the graph, is two amplitudes (one in the positive direction, above the baseline, and an equally sized amplitude in the negative direction, below the baseline).

An “external device” is defined as a device, operated by electrical energy or by any other type of energy, and is connectable to a head unit as which can apply a force on a surface with which it is engaged, for example as an actuator of the head unit. The operation of the external device, when it is connected to the head unit may be periodic or cyclic, such as sinusoidal.

The term “head unit” is defined as a device or unit suitable for connection to an external device, which can be, for example, an external actuator. The head unit includes the connection element and all components and parts required for operation of the device and for engagement of a surface. Typical connection types include threaded connection or snap-fit connection, as used for connection of a head unit to an external device in mechanical engineering. The head unit includes a first, upper portion, and a second, lower portion. The external device is connectable to the upper portion of the head unit.

The term “main longitudinal axis” of a head unit relates to a central longitudinal axis of the head unit, extending along the center of the first upper portion of the head unit.

The term “upper plane” relates to a virtual planar surface, perpendicular to the main longitudinal axis, and tangential to the upper edge of the head unit. An example of the upper surface is illustrated in FIG. 2A, at reference numeral 13/2A.

The term “membrane” of a head unit is defined as an elastic portion disposed at a lower region of the head unit.

The term “protrusion of the membrane” relates to a portion of the membrane which forms a downward-facing protrusion extending downwardly from another portion of the membrane, away from the upper portion of the head unit. The protrusion may be a local protrusion, at the center of the membrane or at any other location in the membrane. The protrusion may be circumferential surrounding the main longitudinal axis, and may form a complete circumference, a segmented circumference, or an incomplete circumference. The protrusion may be elongate or circumferential at another location of the membrane, and may be complete, segmented, or incomplete. Parallel or angled sections of the protrusion, along the main longitudinal axis of the head unit, may be uniform or may be varying at different locations along the protrusion.

The term “extreme point” of a protrusion of the membrane relates to the one or more points of the protrusion having the greatest distance to the upper plane, when measured parallel to the longitudinal axis. Typically, the extreme point is defined when the membrane is at rest state, but the definition is valid also when force is applied to the membrane or the protrusion, and the protrusion is deformed. If the membrane includes multiple protrusions, denoted first protrusion, second protrusion, . . . , Nth protrusion, the extreme points of the protrusions are denoted first extreme point, second extreme point, . . . , Nth extreme point, respectively.

The term “tangential plane” of a protrusion of the membrane relates to a virtual planar surface, perpendicular to the main longitudinal axis and parallel to the upper plane, which is tangential to the extreme point of the protrusion. If the membrane includes multiple protrusions, denoted first protrusion, second protrusion, . . . , Nth protrusion, the tangential planes of the protrusions are denoted first tangential plane, second tangential plane, . . . , Nth tangential plane, respectively.

The term “height of an extreme point (of a protrusion)”, “longitudinal distance of a protrusion” and “height of a protrusion” of the membrane may be used interchangeably, and relate to the distance between the tangential plane of the protrusion and the upper plane.

The term “longitudinal distance between a first protrusion and a second protrusion” of a membrane relates to the distance between the first tangential plane and the second tangential plane.

The term “equidistant membrane” defines a membrane having at least a first protrusion and a second protrusion, such that, when the membrane is in its rest state, the first tangential plane and the second tangential plane coincide. An equidistant membrane can provide graded activation, or have graded force applied thereto, by application of force against a graded surface, as illustrated in FIG. 2E, or by angled application of force, as illustrated in FIG. 2G. A membrane is considered to be equidistant even if it includes one or more third protrusions, whose tangential planes do not coincide with the first and second tangential planes.

The term “graded surface” relates to a surface having a first, lower, plane, and a second, higher, plane, connected by a third plane, perpendicular or angled relative to the first and second planes, for example as illustrated in FIG. 2E. The first and second planes may be horizontal, or may be angled relative to the horizontal. The first and second planes may be parallel to one another, or may be angled relative to one another, at which case the planes are considered to form a graded surface if an extreme highest point of one the lower plane, is lower than an extreme lowest point of the higher plane.

The term “angled application of force” against a planar surface relates to application of force to the head unit, against the planar surface, when the main longitudinal axis of the head unit is angled relative to an axis perpendicular to the planar surface. For example, in FIG. 2G force is applied to head unit 10/2G while main longitudinal axis 25/2G is angled relative to the axis 24/2G disposed perpendicular to the planar surface 30/2G.

The term “rigidity” defines how rigid a specific part or component is, which rigidity is the result of a combination of the hardness of the material used for forming the part or component, and the geometrical shape and dimensions of the part, at different portions thereof.

### BRIEF DESCRIPTION OF THE FIGURES

The foregoing discussion will be understood more readily from the following detailed description of the invention, when taken in conjunction with the accompanying FIGS. 1-57C), in which:

FIG. 1 is a partially sectional schematic diagram of a device according to an embodiment of the present invention, which includes actuator having a head unit including a graded membrane, the head unit being illustrated as a sectional illustration;

FIG. 2A is a sectional illustration of a head unit according to an embodiment of the present invention, the head unit including at least two portions having different rigidity parameters, the first portion including a first connection region for connection to an external device, and second portion including a membrane;

FIG. 2B is a sectional illustration of a head unit according to an embodiment of the present invention, the head unit including a membrane having two conical protrusions, each extending longitudinally away from the first portion of the head unit to a different degree;

FIG. 2C is a sectional illustration of a head unit according to an embodiment of the present invention, the head unit including a membrane having two conical protrusions, each extending longitudinally away from the first portion of the head unit to the same degree, the membrane being at rest state;

FIG. 2D is a sectional illustration of the head unit of FIG. 2C, where the two conical protrusions are equally pressed against a planar surface

FIG. 2E is a sectional illustration of the head unit of FIG. 2C, engaging a surface having two steps at two different heights such that a first of the two conical protrusions is at rest state and the second of the two conical protrusions is pressed against the second step of the surface;

FIG. 2F is a sectional illustration of the head unit of FIG. 2E, following lateral movement of the head unit, such that both conical protrusions are pressed against the second step of the surface;

FIG. 2G is a sectional illustration of the head unit of FIG. 2C disposed adjacent a planar surface, where the longitudinal axis of the head unit is angled, such that the first conical protrusion is pressed against the surface and the second conical protrusion is distant from the surface and at rest state;

FIG. 2H is a sectional illustration of the head unit of FIG. 2G, following rotation thereof such that the longitudinal axis is perpendicular to the planar surface, and where both conical protrusions are pressed against the surface;

FIG. 3 is a schematic illustration of a rotation preventing fast connector for connection of a head unit according to embodiments of the invention to an external device, the connector shown in a closed position;

FIG. 4 is a schematic illustration of the connector of FIG. 3, in a rotation-prevented pre-locked position;

FIG. 5 is a bottom view bottom view planar illustration of a head unit according to one embodiment of the present invention, which is illustrated in more detail in FIG. 6;

FIG. 6 is a sectional illustration of a head unit according to an embodiment of the present invention, the head unit including a membrane having a curved downward-facing surface;

FIG. 7 is a top view planar illustration of the head unit of FIG. 6;

FIG. 8 is a sectional illustration of a head unit according to an embodiment of the present invention, including a membrane having a convex outer bottom surface;

FIG. 9 is a sectional illustration of a head unit according to an embodiment of the present invention, including a membrane having a flat bottom surface;

FIG. 10 is a schematic view of an asymmetrical membrane shape suitable for use in a head unit according to the present invention, the membrane having a first side having a first radius, and a second side having a second radius, which is smaller than the first radius;

FIG. 11 is a sectional illustration of a head unit including a membrane having a convex outer bottom surface, and a circumferential protrusions;

FIG. 12 is a bottom view planar illustration of the head unit of FIG. 13;

FIG. 13 is a sectional illustration of a head unit according to an embodiment of the present invention, the membrane having a graded surface for contacting an exterior surface;

FIG. 14 is a bottom view planar illustration a membrane suitable for use in the head unit of FIG. 13;

FIG. 15 is a sectional illustration of a head unit having a membrane including peripheral graded surfaces, where the peripheral graded surfaces are in their outermost position;

FIG. 16 is a sectional illustration of a head unit having a membrane including peripheral graded surfaces, wherein the peripheral graded surfaces are pressed against a planar surface due to application of force to the head unit;

FIG. 17 is a partial sectional illustration of two head units according to FIG. 15 connected to a plate illustrated in more detail in FIG. 19;

FIG. 18 is a partial sectional illustration of two head units according to FIG. 16 connected to a plate illustrated in more detail in FIG. 19;

FIG. 19 is a perspective illustration of a plate as used in FIGS. 17 and 18;

FIG. 20 illustrates a structure similar to that of FIG. 17, where spaces of the two head units are interconnected and are illustrated prior to application of force;

FIG. 21 illustrates the structure of FIG. 20, following application of force thereto against a planar surface;

FIG. 22 is a perspective illustration of a plate as used in FIGS. 20 and 21;

FIG. 23 is a perspective view illustration of a head unit including a longitudinal membrane according to an embodiment of the present invention, the membrane being pressed against a longitudinal body so as to provide contact compatibility, where the longitudinal body may include, for example, a surface simulating a surface of the human body, or an actual surface of the human body;

FIG. 24 presents a partial sectional illustration of two head units connected to a hinged intermediate unit, where the connection of the head units to the intermediate unit is in one of three possible tilt modes, the two head units being shown in two pressing modes with respect to a body having a circular surface, a first mode without force activation and a second mode with force activation;

FIG. 25 presents a partial sectional illustration of two head units connected to a flexible and springy intermediate unit, where the connection of the head units to the intermediate unit is in one of multiple possible spring tilt modes, the two head units being shown in two pressing modes with respect to a body having a circular surface, a first mode without force activation and a second mode with force activation;

FIG. 26 is a planar illustration of a flexible and springy intermediate unit suitable for use in the system of FIG. 25;

FIG. 27 is a sectional illustration of the head unit of FIG. 15, prior to application of force, and having a sealable portal for fluid filling via a seal, following insertion of fluid into the head unit;

FIG. 28 is a sectional illustration of the head unit of FIG. 27, when pressed against a planar surface;

FIG. 29 is an enlarged sectional illustration of a filling region of the head unit of FIG. 27;

FIG. 30 is a sectional illustration of another head unit according to an embodiment of the present invention, where the entirety of the head unit, including the membrane, is formed as a single integral part, including a hollow or cavity, for example by three-dimensional printing, where the head unit may further include a clamping ring enabling the addition of filling within a sealer;

FIG. 31 is a sectional illustration of an upper portion of the head unit of FIG. 30, without the clamping ring;

FIG. 32 is a sectional illustration of the upper portion of the head unit of FIG. 30, following tightening of the clamping ring;

FIG. 33 presents is a top view planar illustration of the head unit of FIG. 32, following tightening of the clamping ring;

FIG. 34 is a sectional illustration of a head unit according to a further embodiment of the present invention, having a membrane whose outer edges first come into contact with an opposing surface, and wherein an interior space of the membrane has a higher pressure than an atmospheric pressure outside the head unit;

FIG. 35 is a sectional illustration of the head unit of FIG. 34, when a greater force is applied and internal contact areas engage the opposing surface;

FIG. 36 is a sectional illustration of a head unit according to an embodiment of the present invention, having a flat rubber tip;

FIG. 37 is a sectional illustration of a head unit according to an embodiment of the present invention, having a rubber tip with a protruding circumferential border;

FIG. 38 is a sectional illustration of a head unit according to yet another embodiment of the present invention, the head unit being formed of two portions which together define an inner cavity, and having a contact edge similar to that of the head unit of FIG. 15;

FIG. 39 is a sectional illustration of a head unit according to yet another embodiment of the present invention, the head unit being formed of two portions which together define an inner cavity, and having a contact edge similar to that of the head unit of FIG. 16;

FIGS. 40, 41, 42, and 43 are sectional illustrations of head units similar to those illustrated in FIGS. 36, 37, 38, and 39, respectively, having different dimensions than those of FIGS. 36, 37, 38, and 39 and having two circumferential dimensions along the length thereof;

FIG. 44 is a sectional illustration of a connection area between a body of a head unit and a flexible membrane thereof, the connection is sealed by protrusions;

FIG. 45 is a sectional illustration of the flexible membrane of FIG. 44;

FIG. 46 is a sectional illustration of the membrane of FIG. 45 including an inner ring, which hardens the sealing area;

FIG. 47 is a sectional illustration of the connection area of FIG. 44, including the inner ring of FIG. 46;

FIG. 48 is a sectional illustration of an embodiment of a portion of FIG. 47, wherein the inner ring is locked into the membrane;

FIG. 49 is a bottom view planar illustration of a head unit according to another embodiment of the present invention, where the membrane forms pressure zones that are perpendicular to each other;

FIG. 50 is a sectional illustration of an embodiment of the membrane of the head unit of FIG. 49, where the pressure zones have a small height and are relatively rigid;

FIG. 51 is a sectional illustration of another embodiment of the membrane of the head unit of FIG. 49, where the pressure zones have a large height and are relatively flexible;

FIG. 52 is a top view planar illustration of the head unit of FIG. 49;

FIG. 53 is a sectional illustration of a head unit according to an embodiment of the present invention, where the membrane is at rest state, and is not pressed against an external surface;

FIG. 54 is a sectional illustration of the head unit of FIG. 53, where the membrane is in a pressed state and is pressed against an external planar surface;

FIGS. 55A, 55B, and 55C are, respectively, a perspective view illustration, a planar view illustration, and a sectional illustration of an embodiment of a membrane suitable for use in a head unit according to embodiments of the present invention;

FIGS. 56A, 56B, 56C, and 56D are, respectively, a perspective view illustration, side and bottom view planar illustrations, and a sectional illustration of an embodiment of a membrane suitable for use in a head unit according to embodiments of the present invention; and

FIGS. 57A, 57B, and 57C are, respectively, a perspective view illustration, a bottom view planar illustration, and a sectional illustration of an embodiment of a membrane suitable for use in a head unit according embodiment of the present invention.

### DETAILED DESCRIPTION OF THE INVENTION

Examples illustrative of embodiments of the invention are described below with respect to the figures attached hereto. In the figures, identical structures, elements or parts that appear in more than one figure are generally labeled with the same numeral in all figures in which they appear. Dimensions of components and features shown in the figures are generally chosen for convenience and clarity of presentation and are not necessarily shown to scale. The figures are listed below.

Reference is made to all figures constructed and operative under a preferred embodiment of the present invention

FIG. 1 is a partially sectional schematic diagram of a device according to an embodiment of the present invention, which includes actuator having a head unit including a graded membrane, the head unit being illustrated as a sectional illustration. As seen, the device includes an actuator 10/1 having a head unit 14/1, the head unit including a graded membrane 20/1 at a bottom portion thereof. The actuator 10/1 typically includes a motor 12/1, or other electrical driving mechanism, adapted to provide force to the head unit 14/1. Typically, head unit 14/1 is reversibly connectable to actuator 10/1, such that the head unit can be attached and detached from the actuator, as required.

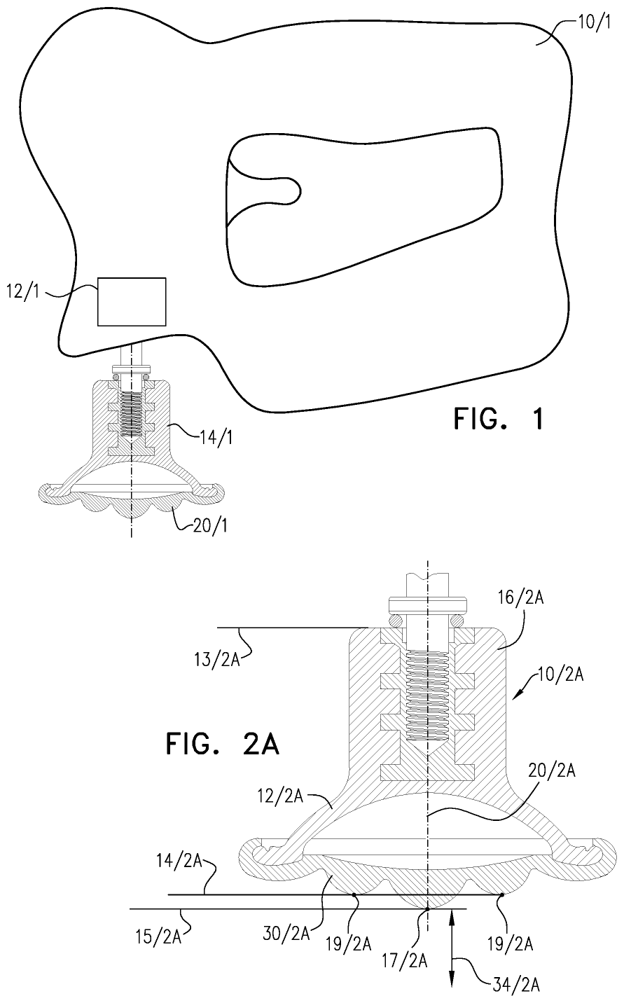

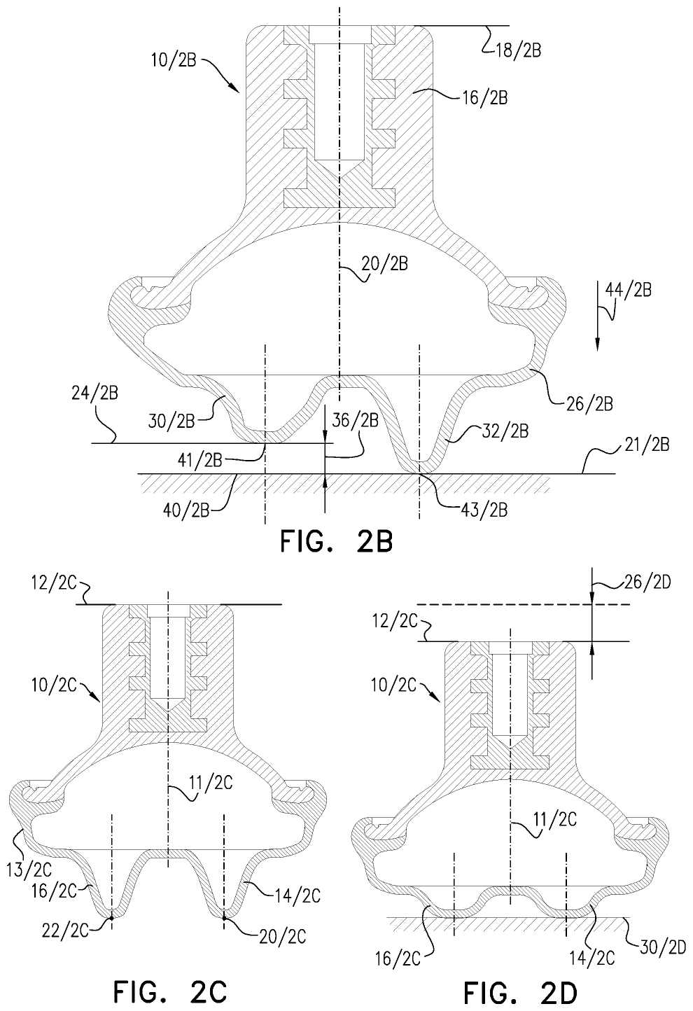

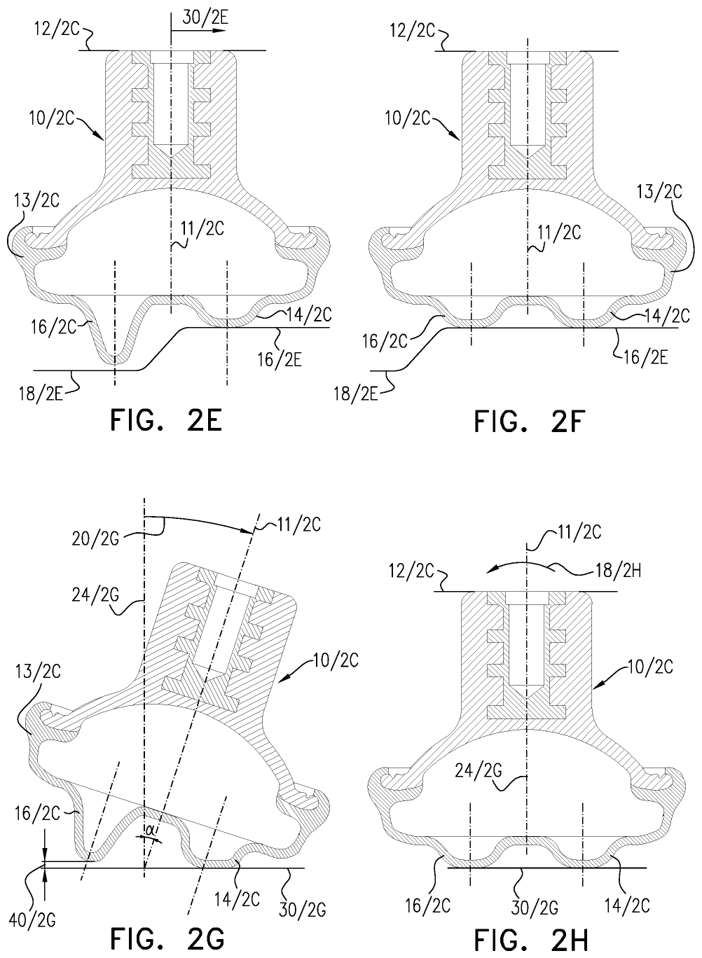

FIG. 2A is a sectional illustration of a head unit 10/2A according to an embodiment of the present invention. The head unit including at least three portions having different rigidity parameters. The first portion, illustrated as the upper portion of the head unit, includes a first connection region 16/2A adapted for connection to an external device, such as actuator 10/1 of FIG. 1. The first portion is typically the most rigid of the three portions.

A main longitudinal axis 20/2A of the first portion, extending through the first connection region 16/2A defines a main longitudinal axis of the head unit. An upper plane 13/2A, perpendicular to main longitudinal axis 16/2A, is defined at an upper edge of first connection region 16/2A.

An intermediate portion 12/2A is disposed between the first connection region 16/2 and a membrane 30/2A, and may have a different rigidity parameters than the first and second portions. Typically, the intermediate portion 12/2A is less rigid than the first connection region 16/2A and more rigid than the membrane 30/2A. However, the intermediate portion may be less rigid than membrane 30/2A, or more rigid than the first portion or the connection region 16/2A.

Membrane 30/2A forms the second portion of the head unit, and is attached to the intermediate portion 12/2A distally to the first connection region. As seen, membrane 30/2A is connected to intermediate portion 12/2A along the perimeter of the membrane and the intermediate portion, such that the center of the membrane is detached from intermediate portion 12/2A and from the first portion. The membrane may be attached to the intermediate portion using any suitable mechanism, such as by mechanical attachment (e.g. using threaded attachment or snap fit attachment), by adhesive attachment, or by soldering.

Membrane 30/2A includes a first, central, protrusion terminating at a first extreme point 17/2A, and a second, circumferential protrusion, terminating at second extreme points 19/2A. A first tangential plane 15/2A is perpendicular to main longitudinal axis 20/2A at first extreme point 17/2A, and a second tangential plane 14/2A is perpendicular to main longitudinal axis 20/2A at second extreme points 19/2A. In some embodiments, longitudinal axes of the first and second protrusions are parallel to one another, such that tangential planes 15/2A and 14/2A are also parallel to one another.

Although the first protrusion is illustrated as being disposed at the center of the membrane, an equivalent protrusion may also be disposed close to, or adjacent, the center of the membrane, and not necessarily directly at the center.

Although the second protrusion is illustrated as being concentric with the first protrusion, it need not necessarily be so, and need not necessarily be centered about the main longitudinal axis of the head unit.

Membrane 30/2A, which defines the second portion of the head unit, is less rigid than the first portion and first connection region 16/2A, and is also softer with respect to a spring action thereof. In some embodiments, the first portion may, for example, have a shore A hardness in the range of 75 to 90, or a shore A hardness of 80. In some embodiments, the second portion and/or the membrane may, for example, have a shore A hardness in the range of 25-35, or a shore A hardness of 30. The shore A value of the first portion, of the second portion, and of the intermediate portion is dependent on the characteristics of the materials from which these portions are formed, and of the thickness and the geometry of each portion.

Membrane 30/2A may be less rigid than intermediate region 12/2A, or may be more rigid than the intermediate region, depending on the application for which it is to be used.

Membrane 30/2A may be formed of any suitable elastic and flexible material. For example, in some embodiments, the membrane is formed of a rubber material. In some such embodiments, the rubber material may include an electrical additive which decreases its electrical resistance. In some such embodiments, the rubber material may include a magnetic additive, which increases the rubber's ability to function as a magnet. In some embodiments, the rubber material changes its mechanical properties when an electrical current is passed therethrough.

In some embodiments, the membrane may be formed of silicone. In some embodiments, the membrane may be formed of a viscoelastic material. In some embodiments, the membrane may be formed of an auxetic material. In some embodiments, the membrane may be formed of polyurethane.

It is appreciated that the difference in rigidity between the first portion, including the first connection region, the intermediate portion, and the membrane, as well as the materials from which the membrane can be manufactured, apply to all embodiments of head units described hereinbelow, and for brevity the discussion is not repeated for each embodiment shown.

During typical use of the head unit, for example for treatment of a treatment surface, the head unit is made to percuss, or is otherwise moved, in a direction indicated by reference numeral 34/2A in a periodic manner, characterized by at least one amplitude and at least one frequency. In some embodiments, the amplitude is in the range of 1 mm to several tens of mm, for example 1 mm to 15 mm. In some embodiments, the frequency is in the range of 1 to 80 Hz. Motion of membrane 30/2A in the direction 34/2A maintains the longitudinal axes of the first and second protrusions substantially parallel to one another, when the head unit is not pressed against an external surface impacting the layout of the membrane.

In some embodiments, the head unit is devoid of an actuator, a motor, or of any electronic components, such that the force for motion or percussion of the head unit is provided only from an external device, such as actuator 10/1 (FIG. 1). Additionally, as seen clearly in FIGS. 1 and 2A, the head unit is devoid of any form of rod or other connection element connecting the membrane to the first portion of the head unit, other than the connection of the perimeter of the membrane to the intermediate portion. For example, there is no rod connecting the center of the membrane to the first portion of the head unit. Specifically, a fluid filled gap exists between the first portion and the center of the membrane, along the longitudinal axis of the head unit. Most of the head units described hereinabove and hereinbelow are suitable for providing mechanical and physical motion relative to a treatment surface engaging the membrane.

In use, a head unit as described hereinabove and hereinbelow, is mechanically attached to, and functionally associated with, an external actuator including a motor, such as actuator 10/1 and motor 12/1 of FIG. 1, via the first connection region 16/2A which forms part of the rigid portion of the head unit. The membrane of the head unit is moved to engage the external treatment surface.

The actuator is then operated such that current provided by the actuator causes motion, or percussion, of the membrane against the treatment surface, in the direction of arrow 34/2A. The actuator operates in a periodic manner and is characterized by at least one amplitude and at least one frequency, which determine the characteristics of the motion or percussion. The treatment is provided in a graded manner, which graded manner may be a result of any one or more of: the geometry of the surface, the geometry of the membrane, and an angle of application of force to the surface. As shown in various examples hereinbelow, the external treatment surface may be rigid or flexible. Additionally, the external surface may be planar, curved, or may have any other suitable contour.

During use of the actuator and percussion or motion of the membrane, force provided by the external actuator (e.g. actuator 10/1, FIG. 1) is transferred from the actuator to connection region 16/2A, and then extends through intermediate region 12/2A to the membrane 30/2A. As such, the force is applied to the perimeter of the membrane, which engages intermediate region 12/2A, and from there spreads toward the center of the membrane, via the protrusions of the membrane.

It is a particular feature of the present invention that the force of the actuator is applied to the membrane (in FIG. 2A, and in the following embodiments of head units), only via the perimeter of the membrane. No force is provided to the center of the membrane via any form of connection element connecting the first portion to the membrane outside of the perimeter, such as a longitudinal rod, as exist in some prior art applications. As mentioned hereinabove, and shown hereinbelow, throughout operation of the actuator and percussion of the head unit there is a fluid filled gap between the center of the membrane and the first portion, along the longitudinal axis of the first portion. FIG. 2B is a sectional illustration of a head unit 10/2B according to an embodiment of the present invention, having at least two portions having different rigidities. The first portion, which is illustrated as the upper portion of the head unit, includes a first connection region 16/2B adapted for connection to an external device, such as actuator 10/1 of Figure No. 1. The main longitudinal axis 20/2B of the head unit extends through the first connection region 16/2B. An upper plane 18/2B is at an upper end of first connection region 16/2B, perpendicular to the main longitudinal axis.

A membrane 26/2B, forming the second portion, is attached via an intermediate portion, to first connection region 16/2B. The membrane 26/2B includes first and second protrusions, here illustrated as conical protrusions terminating in spherical ends. The first conical protrusion 30/2B defines a first extreme point 41/2B, and a first tangential plane 24/2B. The second conical protrusion 32/2B defines a second extreme point 43/2B and a second tangential plane 21/2B. In the illustrated embodiment, the second tangential plane 21/2B is coincidental with an external treatment plane 40/2B, onto which force is to be applied by the head unit.

As seen, the first height of first protrusion 30/2 is smaller than the second height of second protrusion 32/2B, which extends further downward from the membrane connection point than the first protrusion. The distance between the first and second protrusions is indicated by reference numeral 36/2B.

While two conical protrusions are illustrated in FIG. 2B, it is appreciated that the membrane may also include more than two such protrusions, which may also have different heights or distances, as defined using the same terminology and definitions, as also provided hereinabove.

In use, an external force is applied to head unit 10/2B in the direction of arrow 44/2B and a direction of motion of head unit 10/2B, as described in further detail hereinbelow. At first, there is no contact between the second, longer protrusion 32/2B and the external treatment plane 40/2B. As the head unit 10/2B moves in the direction of arrow 44/2B, second protrusion 32/2B engages the external treatment plane 40/2B and is pressed thereon, such that the contact area between the second protrusion 32/2B and the treatment plane 40/2B expands. This type of expansion is typical of flexible conical structures, which the force applied thereto, against a surface, increases. As the head unit 10/2B continues to move in the direction of arrow 44/2B, also first protrusion 30/2B engages the external treatment plane 40/2B and is pressed thereon, such that the contact area between the first protrusion 30/2B and the treatment plane 40/2B expands. Because of the distinct heights of the two protrusions, the engagement of the treatment plane and the force applied thereto are graded, and non-continuous, until the formation of a substantial contact area.

Stated differently, as head unit is continuously moved in the direction of arrow 44/2B towards and/or against treatment plane 40/2B, during the application of force, there will be a transition between the contact with the second protrusion and the contact with the first protrusion, resulting in graded and non-continuous contact between the membrane 26/2B and the external treatment plane 40/2B.

FIG. 2C is a sectional illustration of a head unit 10/2C, similar to the head unit 10/2A, and defining a main longitudinal axis 11/2C and an upper plane 12/2C. Head unit 10/2C includes an equidistant membrane 13/2C having a first protrusion 16/2C terminating at a first extreme point 22/2C, and a second protrusion 14/2C terminating at a second extreme point 20/2C. As seen, when no force is applied to head unit 10/2C, and membrane 13/2C is at rest state, the first and second protrusions have the same height, or longitudinal distance, from the upper plane 12/2C.

FIG. 2D shows the head unit head unit 10/2C of FIG. 2C, where the first and second protrusions 16/2C and 14/2C are equally pressed against an external treatment plane 30/2D, following movement of the head unit 10/2C toward the treatment plane along the longitudinal direction of the head unit. The distance traversed by the head unit, toward the treatment plane 30/2D, is indicated by reference numeral 26/2D. As seen, in some cases, when the protrusions of equidistant membrane 13/2C are pressed onto a surface, the membrane remains equidistant, and the distant between the contact areas of the protrusions with the treatment surface, and the upper plane 12/2C, remains fixed.

FIG. 2E shows the head unit 10/2C of FIG. 2C, engaging a graded surface having a first, higher, plane 16/2E, and a second, lower plane 18/2E. As seen, when force is applied to head unit 10/2C toward the graded surface, initially, second protrusion 14/2C engages, and is pressed against, the higher plane 16/2E of the graded surface, while the first protrusion 16/2C is disposed above, and does not engage, lower plane 18/2E. Movement of the head unit 10/2C along the graded surface, in a direction indicated by arrow 30/2E, while continuing to apply force to the head unit, results in the state illustrated in FIG. 2F and described hereinbelow.

FIG. 2F shows the head unit 10/2C of FIG. 2C adjacent the graded surface of FIG. 2E, following motion of the head unit along the graded surface in the direction indicated by arrow 30/2E in FIG. 2E. As seen, following motion of the head unit, both protrusions 16/2C and 14/2C engage, and are pressed against, the higher surface 16/2E of the graded surface, such that, with respect to the higher plane 16/2E, the position of head unit 10/2C is identical to that illustrated in FIG. 2D. It is appreciated that the manner of force application to a graded surface, described herein with respect to FIGS. 2E and 2F, results in graded application of force even though the membrane 13/2C is an equidistant membrane, as defined above.

FIG. 2G shows the head unit 10/2C of FIG. 2C, during angled application of force against an external treatment plane 30/2G. As seen, the main longitudinal axis 11/2C of the head unit 10/2C is tilted in a direction 20/2G to be at an angle [symbol] relative to a virtual axis 24/2G which is perpendicular to treatment plane 30/2G. As such, when force is applied to the head unit 10/2C in the direction of longitudinal axis 11/2C, the second protrusion 14/2C is pressed against plane 30/2G, while the first protrusion 16/2C remains above the plane 30/2G, and at a distance 40/2G therefrom. It is appreciated that if the head unit 10/2C were tilted in the opposing direction, for example for main longitudinal axis 11/2C to form an angle − [symbol] relative to a virtual axis 24/2G, the first protrusion 16/2C would be pressed against surface 30/2G, while the second protrusion 14/2G would remain above the surface.

FIG. 2H shows the head unit 10/2C of FIG. 2C adjacent the planar surface 30/2G of FIG. 2G, following tilting of the head unit 10/2C in a direction 18/2H, which causes the longitudinal axis 11/2C of the head unit to coincide with the virtual longitudinal axis 24/2G, and to be perpendicular to plane 30/2G. As seen, following such tilting motion of the head unit, both protrusions 16/2C and 14/2C engage, and are pressed against, the external plane 30/2G, such that, with respect to surface 30/2G, the position of head unit 10/2C is identical to that illustrated in FIG. 2D. It is appreciated that the angled application of force, described herein with respect to FIGS. 2G and 2H, results in graded application of force even though the membrane 13/2C is an equidistant membrane, as defined above.

FIG. 3 is a schematic illustration of a fast connector 10/3 for connection of a head unit according to the present invention to an external device, such as an actuator. The fast connector 10/3 includes a rotation preventing mechanism 16/3, and is illustrated in a closed position of the connector.

FIG. 4 is a schematic illustration of the fast connector 10/3 of FIG. 3, where rotation preventing mechanism 16/3 is in a rotation-prevented, pre-locked position.

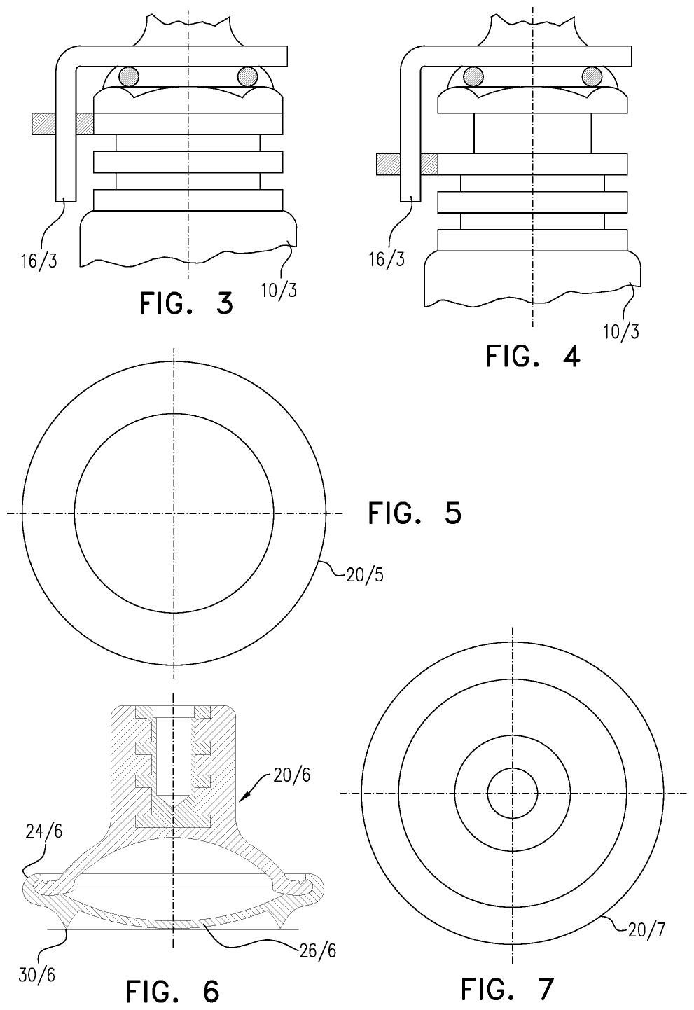

FIG. 5 is a bottom view planar illustration 20/5 a head unit 20/6 according to the present invention, which head unit is illustrated in FIG. 6.

FIG. 6 is a sectional illustration of a head unit 20/6 according to an embodiment of the present invention. Head unit 20/6 includes a membrane 24/6 having a downward facing curved surface 26/6. The spherical surface 26/6 includes a peripheral and circumferential protruding ring 30/6, which terminates at a sharp end.

FIG. 7 is a top view planar illustration 20/7 of the head unit 20/6 of FIG. 6.

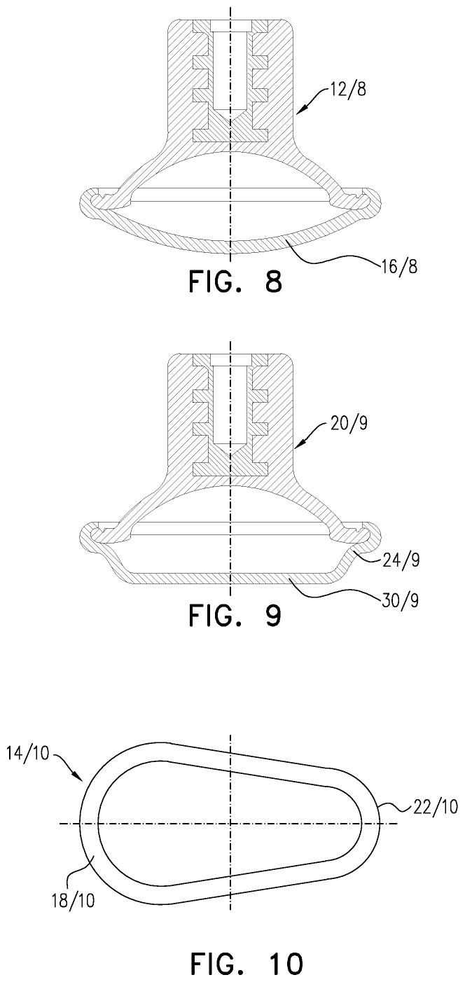

FIG. 8 is a sectional illustration of a head unit 12/8 including a membrane 16/8, which membrane has a downward facing, outwardly protruding curved surface. In typical use, force is applied to the head unit, pushing the membrane against a contact surface, or treatment surface. The contact surface may be flexible or rigid. When the applied force grows, a balance between the flexibility of the contact surface and the flexibility of the membrane determines the shape or configuration of the bottom surface of the membrane.

In some embodiments, when the applied force is continuously increased, an engagement area at which the membrane engages the contact surface also continuously increases.

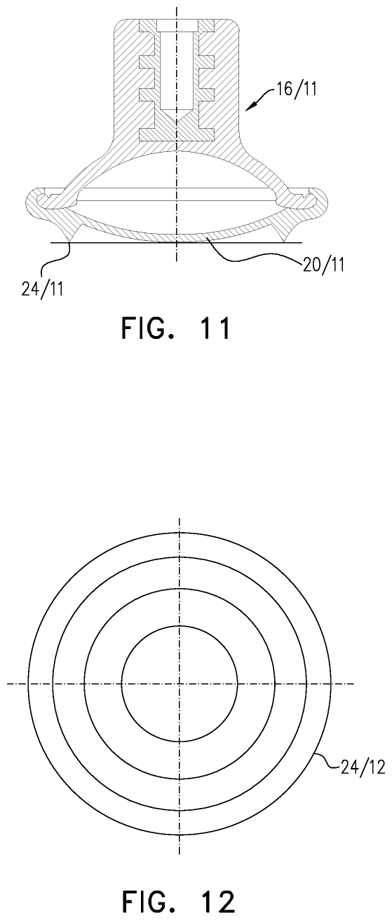

FIG. 9 is a sectional illustration of a head unit 20/9 according to an embodiment of the present invention, including a membrane 24/9 having a flat planar downward facing surface 30/9.

FIG. 10 is a schematic view of an asymmetrical membrane 14/10 suitable for use in a head unit according to embodiments of the present invention. As seen, membrane 14/10 includes a first side 18/10 having a first radius, and a second side 22/10 having a second radius, where the second radius is smaller than the first radius.

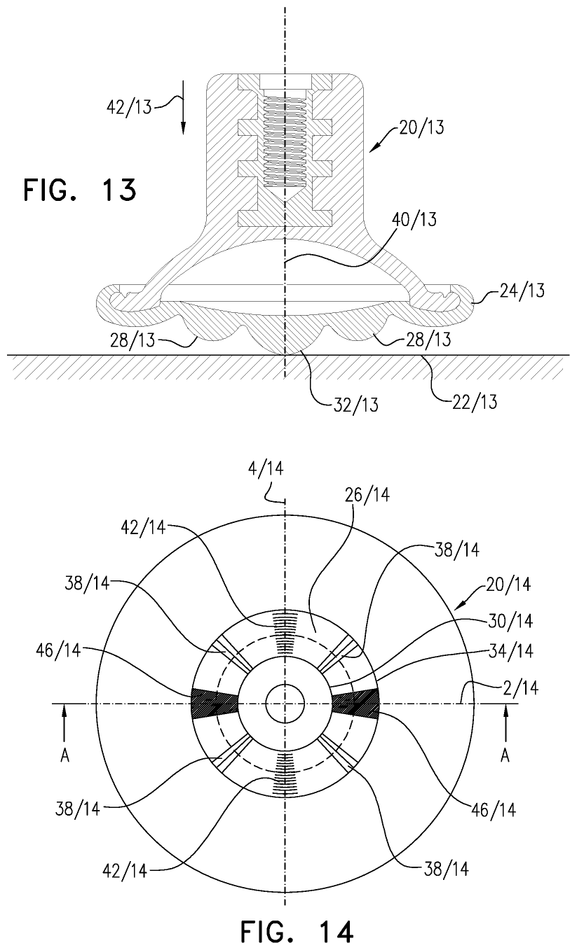

FIG. 11 is a sectional illustration of an asymmetrical head unit 16/11, whose peripheral shape, or membrane, is depicted in FIG. 10. A lower surface 20/11 of the membrane of head unit 16/11 is curved, or spherical. The membrane includes a peripheral protruding ring 24/11, which terminates at a sharp end. Protruding ring 24/11 causes the engagement area between the membrane and a contact surface to be gradually increased, when force is applied to the membrane. Additionally, ring 24/11 assists in preserving a material, such as a treatment gel or cream, which was spread on the membrane or on the head unit prior to use thereof, from being spread outside of the engagement area.

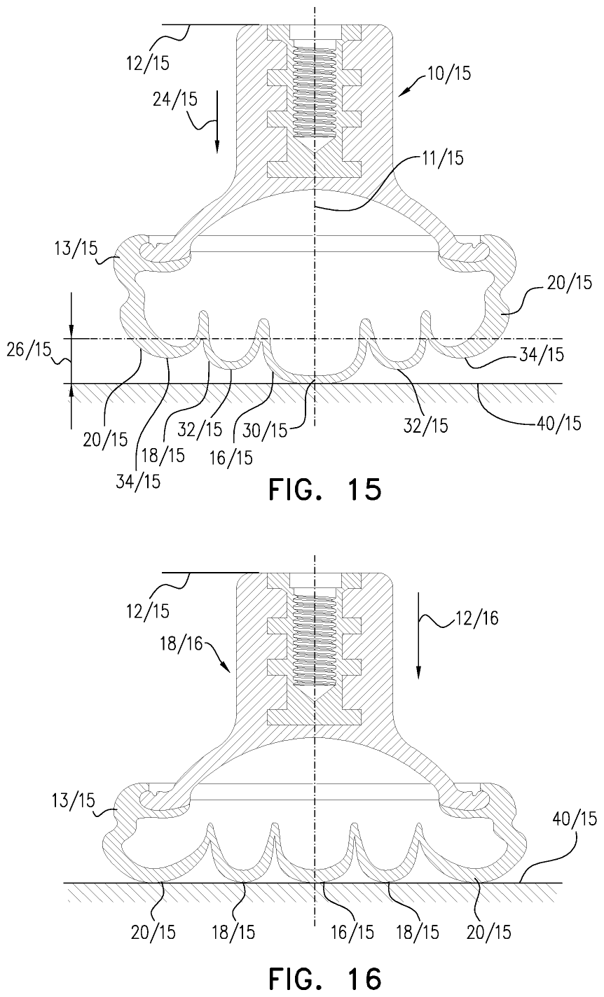

FIG. 12 is a bottom view planar illustration 24/12 of head unit 20/13 illustrated in FIG. 13.

FIG. 13 is a sectional illustration of a head unit 20/13 arranged about a main longitudinal axis 40/13. The head unit includes a membrane 24/13 having a graded contact surface defined by a central protrusion 32/13 and a circumferential protrusion 28/13. When head unit 20/13 is pushed in the direction of arrow 42/13 using a continuously increasing force, membrane 24/13 engages an external surface 22/13. The engagement area between the external surface and the membrane is gradual, and is staggered based on the structure of the protrusions 28/13 and 32/13 of the membrane.

FIG. 14 is a bottom view planar illustration of a membrane 20/14, suitable for use in the head unit of FIG. 13. Axes 2/14 and 4/14 are virtual axes used to assist in identification of heights, distances, and other relative dimensions. The circumferential portion 26/14, which may be similar to circumferential protrusion 28/13 of FIG. 13, is bound by interior contour 30/14 and exterior contour 34/14. While contours 30/14 and 34/14 are illustrated as circular contours, it is appreciated that they may have other shapes as well, provided that they are closed contours.

Circumferential portion 26/14 includes four waves, in a direction surrounding the main longitudinal axis of the head unit, such as axis 40/13 of FIG. 13. In some embodiments, the circumferential portion 26/14 may be sinusoidal, and may have four maximum points and four minimum points, where all the maximum points are equidistant to an upper plane of the head unit and all the minimum points are equidistant to the upper plane of the head unit. In another embodiment, the circumferential portion 26/14 may have waves of varying dimensions. For example, the circumferential portion 26/14 may include four maximum points 38/14 all being equidistant to the upper plane of the head unit. Two local minimum points 42/14 are equidistant relative to the upper plane of the head unit, such that the distance of points 42/14 from the upper plane is greater than the distance of points 38/14 from the upper plane. Two absolute minimum points 46/14 are equidistant relative to the upper plane of the head unit, such that the distance of points 46/14 from the upper plane is greater than the distance of points 42/14 from the upper plane.

Similarly to that described hereinabove with respect to FIG. 13, when force is applied to a head unit including membrane 20/14, pushing the membrane toward an external surface, the first points to contact and be pressed against the external surface will be absolute minimum points 46/14. As additional force is applied, also local minimum points 42/14 will press against the surface, and maximum points 38/14 will be the last to engage the surface, and the contact area with the surface will increase. Thus, the membrane of FIG. 14 is suitable for graded application of force to a surface.

FIG. 15 is a sectional illustration of a head unit 10/15 according to an embodiment of the present invention, the head unit being defined about a main longitudinal axis 11/15 and defining an upper plane 12/15. Head unit 10/15 includes a membrane 13/15 having a first, central, protrusion 16/15 defining a first extreme point 30/15, a second, circumferential protrusion 18/15, concentric to first protrusion 16/15 and defining second extreme points 32/15, and a third, circumferential protrusion 20/15, concentric to the first and second protrusions, and defining third extreme points 34/15. The first height of first protrusion 16/15 is greater than the second height of second protrusion 18/15, which in turn is greater than the third height of third protrusion 20/15.

During application of a force in direction 24/15 to head unit 10/15 against a planar external surface 40/15, an engagement area at which membrane 13/15 engages the external surface 40/15 increases, due to contraction of the membrane as indicated by arrows 26/15.

External surface 40/15 may have different configurations, and may be similar to a surface of the human body or may be a surface of the human body, for example during physiotherapy or other treatments.

In embodiments in which the external surface is flexible, when force is applied to the head unit 10/15 such that the membrane 13/15 presses against the external surface, a balance between the flexibility of the external surface and the flexibility of the membrane determines the shape or configuration of the bottom surface of the membrane. When there is a change in the force applied, the configuration of the membrane changes accordingly. Thus, if the external surface 40/15 illustrated in FIG. 15 were flexible, the configuration of the membrane, and the engagement area between the membrane and the external surface, would be different from that illustrated, due to the flexibility of the contact surface. For example, the surface of a body portion of a patient, such as the surface of their arm, abdomen, or foot, may be considered flexible surfaces.

As force is released and the membrane 13/15 moves away from the external surface 40/15, the engagement area decreases to the point of complete separation between the membrane and the external surface, at which time the membrane surface is at, or near, a rest state similar to that illustrated.

In some embodiments, during application of an increasing force to the head unit pushing against a flexible external surface, a contact area of the membrane with the flexible external surface increases, resulting in a decrease of a distance between the first and second protrusions. As a result, the flexible external surface is pinched and released between the first and second protrusions, in a direction perpendicular to the main longitudinal axis.

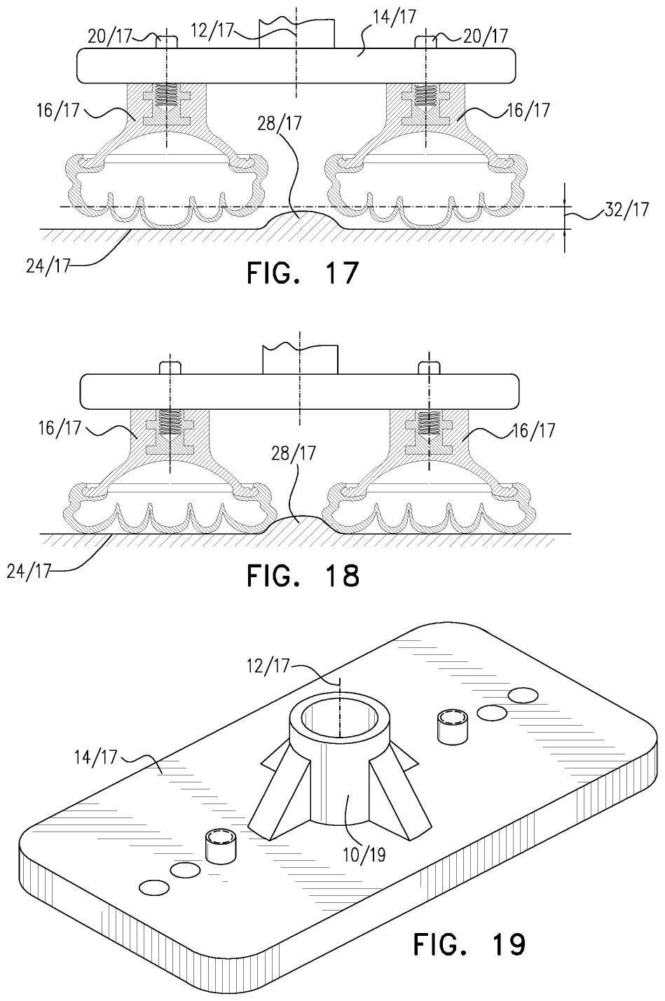

FIG. 16 is a sectional illustration of a head unit 18/16, similar to the head unit of FIG. 15, following application of force thereto in the direction 12/16. As seen in FIG. 16, the protrusions 16/15, 18/15, and 20/15 have been pressed against planar external surface 40/15. As explained above, the transition from the configuration shown in FIG. 15, to that shown in FIG. 16, is dictated by the force applied to the head unit pushing the membrane 13/15 against the external surface 40/15. As the force increases, due to the balance between the flexibility of the external surface and the flexibility of the membrane, as well as due to the structure of the membrane, the increase in the engagement area between the membrane and the external surface is graded and discontinuous. As mentioned above, in this embodiment, the flexibility or rigidity of the external surface substantially dictates the configuration of the membrane.

As clear from a comparison of FIGS. 15 and 16, both in the rest state shown in FIG. 15 and following application of force to head unit 18/16 in the direction 12/16 as shown in FIG. 16, the longitudinal axes of the protrusions 16/15, 18/15, and 20/15 remain substantially parallel to one another. Additionally, in both states, a fluid filled gap exists between first portion 10/15 and the center of the membrane in protrusion 30/15, along main longitudinal axis 11/15.

FIG. 17 is a partial sectional illustration of a device including two head units 16/17 according to the present invention, similar to the head units illustrated in FIG. 15. In the illustrated embodiment, the head units 16/17 are mechanically connected to an intermediate base plate 14/17, by screws 20/17, although any other suitable method of connection of the head units to the intermediate base plate is considered within the scope of the present invention. Intermediate base plate 14/17 is arranged about a main axis 12/17, via which the base plate may be connected to an actuator, such as, for example, actuator 1/10 of FIG. 1. The base plate 14/17 is adapted to be connected to the actuator using any suitable mechanism, such as by threaded connection or by snap fit connection.

A generally planar external surface 24/17 which is adapted to be engaged by head units 16/17, includes a protrusion, or bulge, 28/17 extending outwardly therefrom. This configuration may occur, for example, in an area of skin along the spine of a patient. When force is applied to the intermediate base plate 14/17 and/or to head units 16/17, in a longitudinal direction toward external surface 24/17, the head units close the distance 32/17 and are pressed against external surface 24/17.

FIG. 18 is a partial sectional illustration of the device of FIG. 17, where head units 16/17 are pressed against external surface 24/17, similarly to the configuration illustrated in FIG. 16. In the illustrated embodiment, the head units press against external surface 24/17, but do not apply force to the protrusion 28/17. The configuration illustrated in FIG. 18 may be reached by applying additional force to the configuration shown in FIG. 17, such that the membranes of head units 16/17 fully engage the external surface 24/17. However, also in the configuration of FIG. 18, undesired contact with the protrusion, which may for example represent skin along the spine of a subject, is prevented.

Figure No. 19 is a perspective view illustration of intermediate base plate 14/17 shown in FIGS. 17 and 18, including an axial connector 10/19 thereof, which is arranged about main axis 12/17.

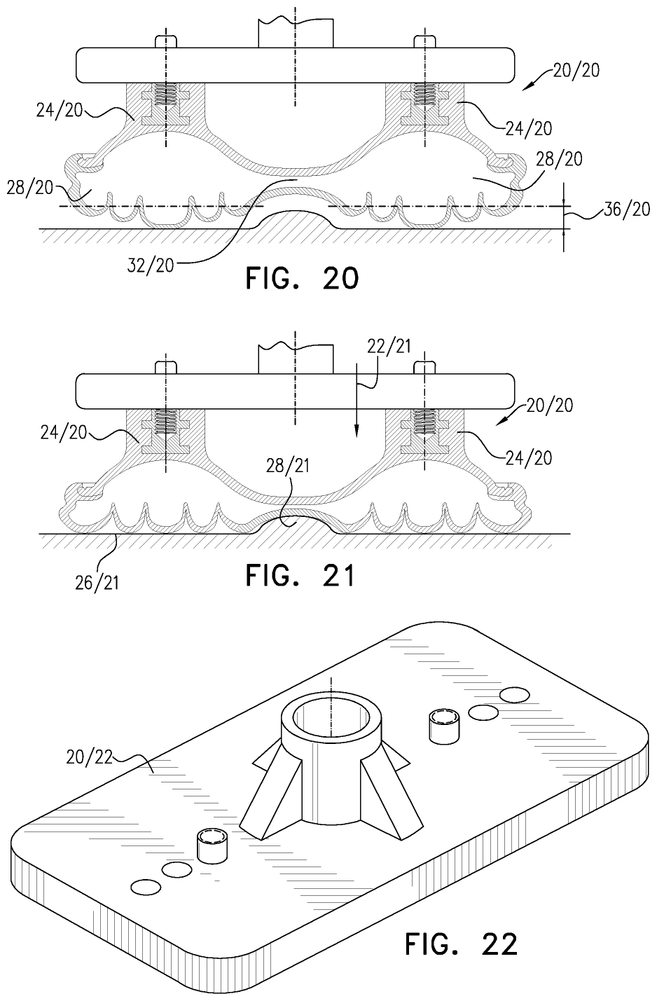

FIG. 20 illustrates a structure 20/20 similar to that of FIG. 17. The main difference between FIGS. 17 and 20 is that in FIG. 20, cavities or hollows 28/20 of the two head units 24/20 are interconnected by a passage 32/20, allowing fluid flow between the two head units. FIG. 20 illustrates a configuration which exists prior to application of force to the head units.

FIG. 21 illustrates the structure 20/20 of FIG. 20, following application of a force in a direction 22/21 to the structure, which force causes structure 20/20, and specifically head units 24/20, to approach and/or engage an external surface 26/21 by closing the space 36/20 shown in FIG. 20. One of the characteristics of this structure is the ability to bypass, or avoid, protrusion 28/21 which is present in external surface 26/21, and is similar to protrusion 28/17 of FIG. 17.

FIG. 22 is a perspective view illustration of an intermediate base plate 20/22, used to connect the head units of FIGS. 20 and 21. Intermediate base plate 20/22 is similar in structure to intermediate base plate 14/17 of FIG. 19.

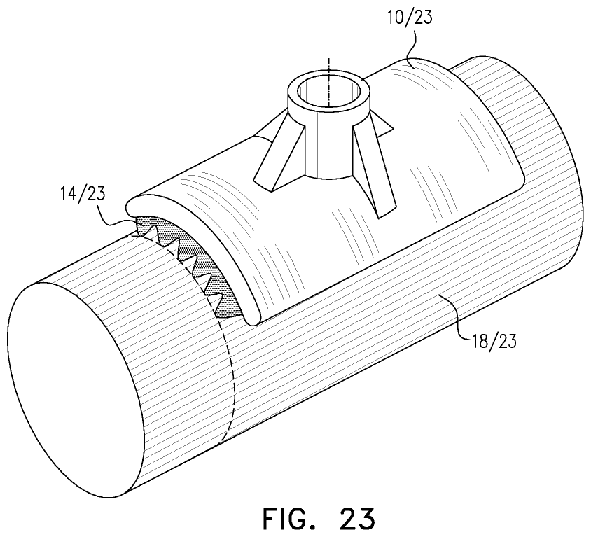

FIG. 23 is a perspective view illustration of a head unit 10/23 according to another embodiment of the present invention. Head unit 10/23 includes a longitudinal membrane 14/23, adapted to engage an external contact surface of an elongate body 18/23, such as a human arm or leg. The structure of membrane 14/23, which is elongate in one direction, and curved in the transverse direction, allows for compatibility of contact with elongate body 18/23, which compatibility is at least in part due to the flexibility of the elongate body 18/23 and the flexibility of the membrane 14/23.

When force applied to the head unit, pushing it against the external surface of the elongate body 18/23, is increased, there is an increase in the size of an engagement area at which the membrane engages the external surface.

The external surface of the elongate body 18/23 may have different spatial configurations. In some embodiments, the external surface may be similar to a surface of a human body part, or may actually be a surface of a human body part.

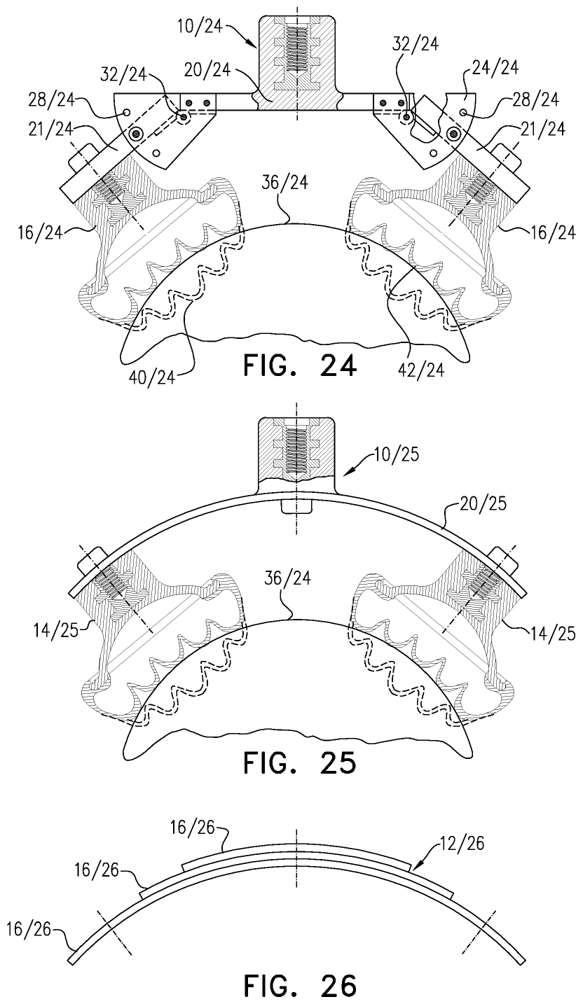

FIG. 24 is a partial sectional illustration of a device 10/24 including two head units 16/24, both of which are connected to an intermediate base plate. The intermediate base plate includes a first segment 20/24 including the first connection region for connection to an external device, as well as second and third segments 21/24 that are pivotable relative to the first segment, about axes 32/24. Each of the two head units 16/24 is attached to one of the second and third segments 21/24. Extending from the first segment 20/24 of the intermediate base plate, on both sides thereof, are extension plates 24/24, each of which includes three bores 28/24. Each of the second and third segments 21/24 of the intermediate base plate, as well as the head units 16/24 connected thereto, may be at one of three angular orientations relative to the first segment 20/24 of the intermediate base plate, where the angular orientation is dependent on the specific bore 28/24 which is in engagement with the second or third segments.

The membranes of head units 16/24 are illustrated in two operative orientations with respect to a body having a curved or hemispherical surface 36/24. In the orientation indicated by reference numeral 40/24, no force is applied to the membrane, and the membrane assumes the shape it has in rest state. By contrast, in the orientation indicated by reference numeral 40/24, force is applied to the membranes, for example via application of force to the intermediate base plate, and the membranes engage surface 36/24.

FIG. 25 is a partial sectional illustration of a system 10/25 including two head units 14/25 that are connected to an intermediate base plate 20/25. The intermediate base plate 20/25 is flexible and springy, and is similar to that shown in FIG. 24 in that the head units are angled relative to the center of the base plate. However, in the embodiment of FIG. 25, the angle of the head units 14/25 is determined by the spring-based pivoting facilitated by the intermediate base plate. The membranes of the head units 14/25 are shown in two operative orientations relative to a body having a hemispherical surface 36/24, as described hereinabove with respect to FIG. 24.

FIG. 26 is a planar, side view illustration of a spring device 12/26 that can be used as the intermediate base plate of Figure no. 25. The arrangement of FIG. 26 enables changing of the flexibility and or springiness of the two head units by changing the location of the head units to any of three leveled options 16/26, shown as an example. This type of spring systems is commonly used in the automotive industry.

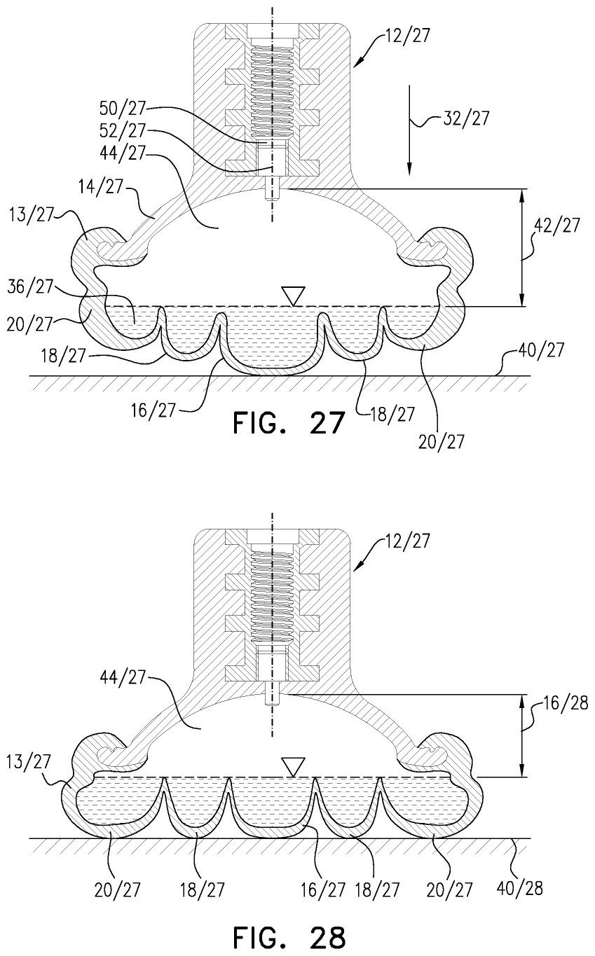

FIG. 27 is a sectional illustration of a head unit 12/27, similar to that shown in FIG. 15, where the membrane 13/27 thereof is in rest state, without any application of force thereto. Membrane 13/27 of head unit 12/27 may be relatively flexible or relatively rigid, and mechanically connects to intermediate portion 14/27 of the head unit. As the force applied to the head unit is increased, the engagement area between protrusions 16/27, 18/27, and 20/27 of the membrane and an external plane 40/27 are increased in a graded and discontinuous manner.

The illustrated head unit 12/27 has a liquid 36/27 disposed therein, which liquid may be of different types and typically fills the membrane. The liquid is inserted into the head unit via a portal 50/27. Following insertion of the fluid, the portal is sealed using a sealing screw 52/27, thereby to create initial air pressure in the internal volume 44/27 created, when the membrane is in rest state, between the seal and the liquid within 36/27 the head unit. As seen, in this configuration, the height of the cavity 44/27 is indicated by reference numeral 40/27.

FIG. 28 is a sectional illustration of head unit 12/27 of FIG. 27, following application of force thereto in a direction 32/27 shown in FIG. 27. In the configuration of FIG. 28, the membrane 13/27 is pressed onto an external surface 40/28. The increase in force causes the initial height of cavity 44/27 to decrease from height 42/27 of FIG. 27 to a height indicated by reference numeral 16/28, thus reducing the dimension of cavity 44/27 and increasing the pressure therein. This results in the engagement area between the membrane and the external surface 40/28 including most of each of the protrusions 16/27, 18/27, and 20/27.

As clear from a comparison of FIGS. 27 and 28, both in the rest state shown in FIG. 27 and following application of force to head unit 12/27 in the direction 16/28 as shown in FIG. 28, the longitudinal axes of the protrusions 16/27, 18/27, and 20/27 remain substantially parallel to one another. Additionally, in both states, a fluid filled gap, including liquid 36/27 and gas, exists between the first portion and the center of the membrane in protrusion 16/27, along main longitudinal axis 52/27.

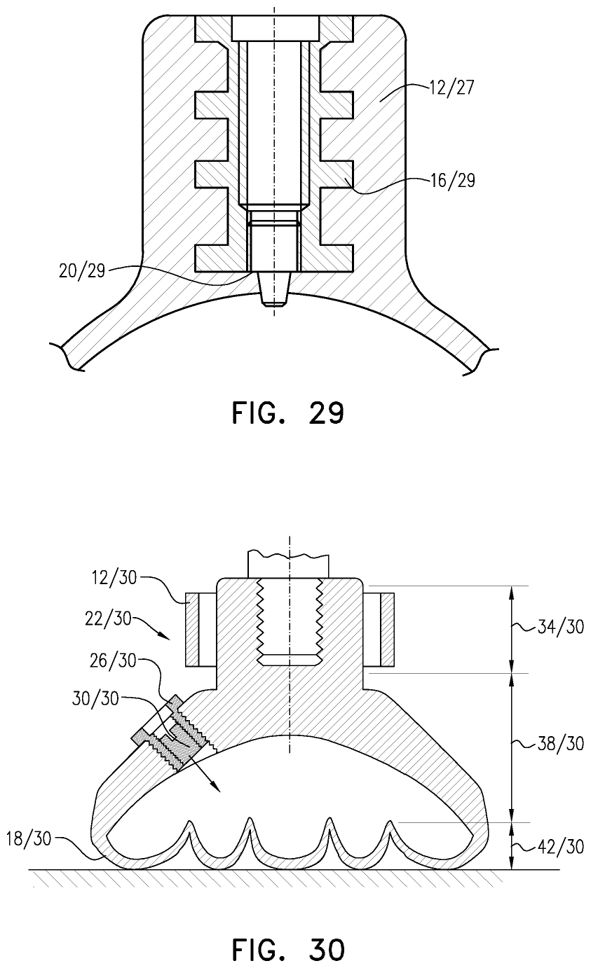

FIG. 29 is an enlarged sectional illustration of the filling portal shown in FIG. 27. The head unit 12/27 includes an internal connector 16/29 forming at least part of the first connection region for connection to an external device, such as actuator 10/1 of FIG. 1. The head unit 12/27 further includes the filling portal as illustrated in Figure no. 27, as well as a seal 20/29, which seals the portal, and may be similar to seal 52/27 of FIG. 27. The hollow of head unit may be filled via the portal by any suitable fluid, which may include only liquid, a mixture of liquid and gas, or condensed gas such as condensed air.

FIG. 30 is a sectional illustration of a head unit 22/30 according to another embodiment of the present invention, where the entirety of the head unit, including membrane 18/30, is formed as a single an integral part, for example by three dimensional printing. Use of such an integrally formed head unit may resolve problems that may arise from the need to form a seal between the first portion of the head unit and the membrane.

In some embodiments, a clamping ring 12/30 is disposed about the first portion of the head unit 22/30, so as to reinforce the first portion of the head unit indicated by arrow 34/30. The intermediate portion of the head unit is indicated by arrow 38/30, and the second portion of the head unit is defined by arrow 42/30, which includes the membrane 18/30.

In some embodiments, a portal 26/30 for filling the cavity of the head unit with fluid is provided within a wall of the head unit, for example in region 38/30 thereof. The portal may be sealed using a seal 30/30.

FIG. 31 is a sectional illustration of the first, upper portion 34/30 of the head unit 22/30 of FIG. 30, without clamping ring 12/30.

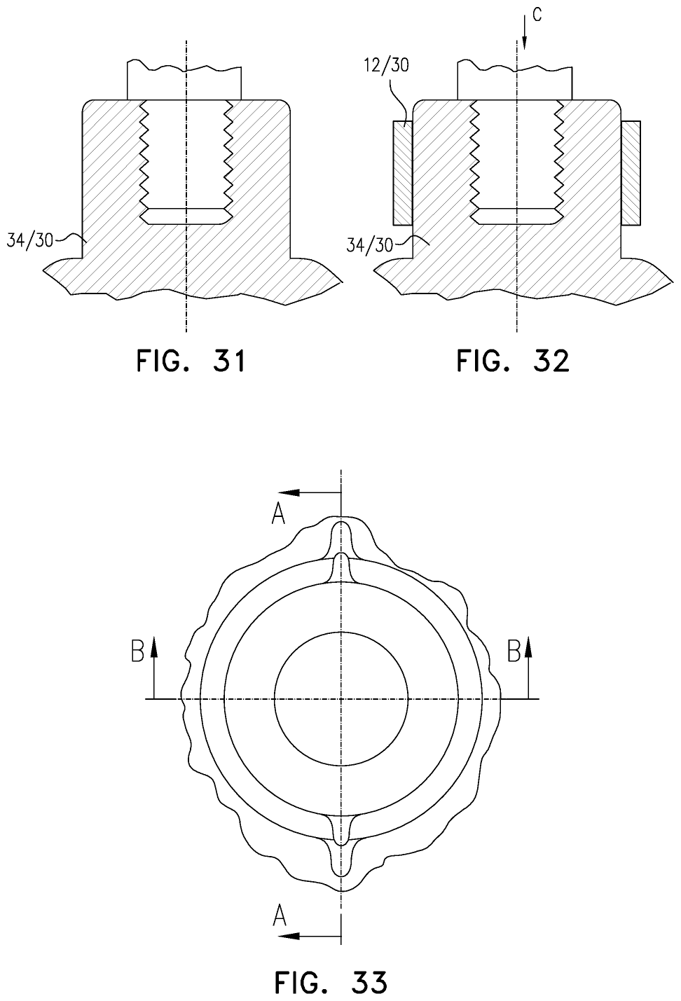

FIG. 32 is a sectional illustration, taken along section line B-B of FIG. 33, of first, upper portion 34/30 of the head unit 22/30, following tightening of the clamping ring 12/30. The use of clamping rings, as illustrated herein, is common and acceptable in the field of hydraulic piping.

FIG. 33 presents a top view planar view illustration of the head unit of FIG. 32, following tightening of the ring 12/30.

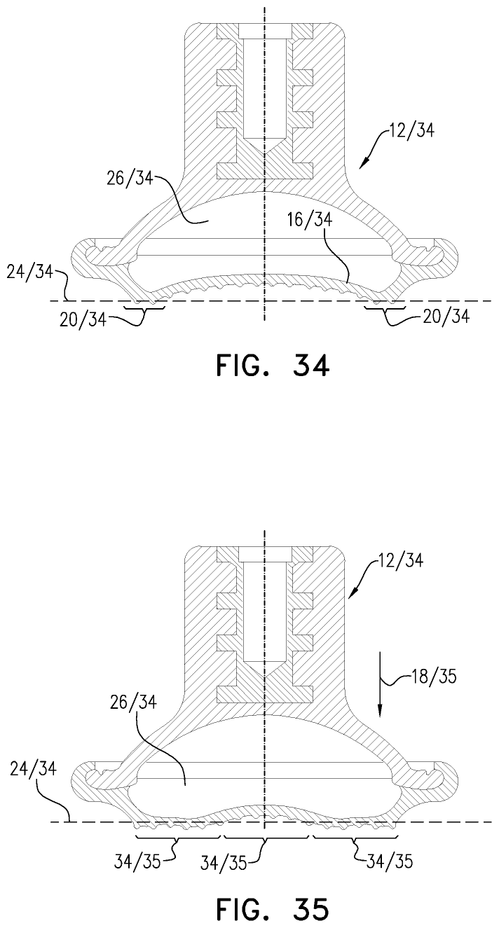

FIG. 34 is a sectional illustration of a head unit 12/34 according to a further embodiment of the present invention. Head unit 12/34 includes a membrane 16/34, whose outer peripheral edges 20/34 are the first to come into contact with an opposing external surface 24/34, when force is applied to the head unit pressing it toward the external surface. In the illustrated embodiment, the external surface 24/34 is planar. In some such embodiments, the force causes the interior pressure within a cavity 26/34 of the head unit to be greater than an atmospheric pressure outside the head unit.

FIG. 35 is a sectional illustration of head unit 12/34 of FIG. 34, following application of force thereto, against external surface 24/34, in a direction indicated by arrow 18/35. As in, when force is applied to the head unit, initially outer peripheral edges 20/34 of the membrane engage the opposing external surface 24/34. As the force in direction 18/35 is increased, the force on the head unit is correspondingly increased resulting in an increase in pressure within the internal volume 26/34 of the head unit, which decreases in height. As such, further portions of the membrane, indicated by reference numerals 34/35, may engage the external surface 24/34. When the contact surface is not planar, the membrane configuration can be adjusted to match the surface. This may be important, for example, for treatment of the surface of a human knee.

FIG. 36 is a sectional illustration of a head unit 12/36 according to an embodiment of the present invention, having a flat rubber end 16/36, distal to an upper surface 18/36 of the head unit.

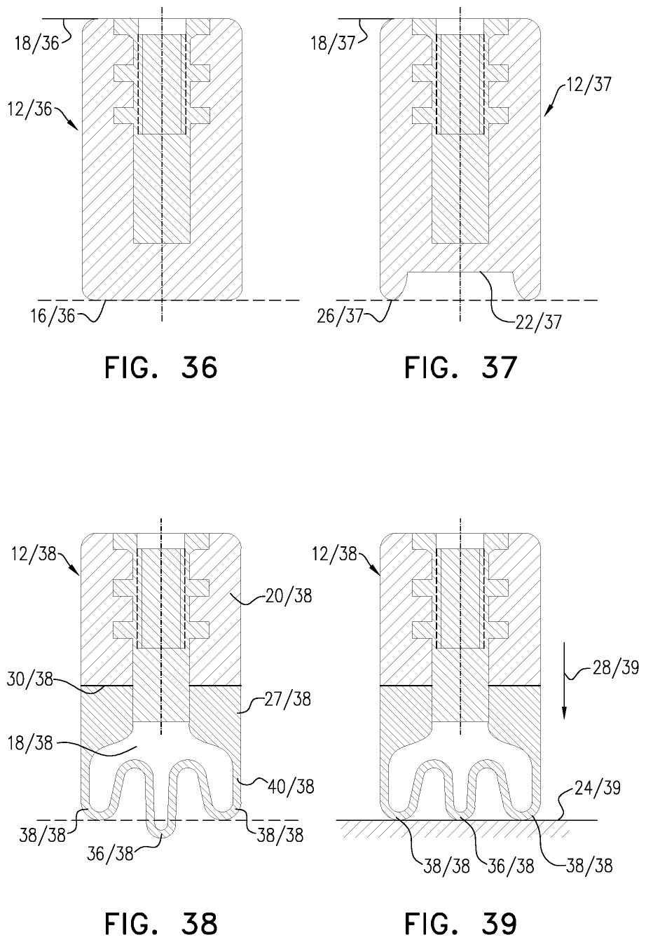

FIG. 37 is a sectional illustration of a head unit 12/37 according to yet another embodiment of the present invention, having a rubber tip 22/37 including a protruding circumferential border 26/37, the rubber tip 22/37 being distal to an upper surface 18/37 of the head unit.

FIG. 38 is a sectional illustration of a head unit 12/38 according to a further embodiment of the present invention, including a membrane 40/38. The head unit 12/38 is formed of an upper section 20/38 and a lower portion 27/38, which together define an inner cavity 18/38. The upper and lower sections may be adhered to one another at an engagement region 30/38 thereof. In its rest state, membrane 40/38 includes a central protrusion 36/38 and a circumferential protrusion 38/38, where central protrusion 36/38 has a greater height than circumferential protrusion 38/38.

FIG. 39 is a sectional illustration of head unit 12/38 of FIG. 38, when force is applied to the head unit in a direction indicated by arrow 28/39, pressing the membrane against an external surface 24/39. The force applied to the head unit dictates the configuration of the protrusions 36/38 and 38/38 of the membrane, when they engage the external surface.

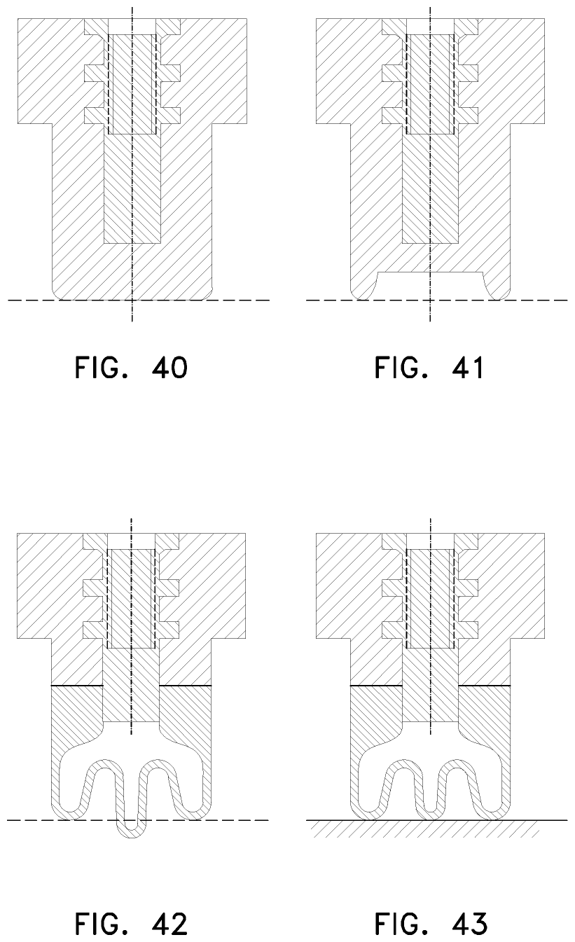

FIGS. 40, 41, 42 and 43 are sectional illustrations of head units similar to those illustrated in FIGS. 36, 37, 38 and 39, having different dimensions than the corresponding head units of FIGS. 36, 37, 38 and 39. Additionally, each of the head units of FIGS. 40, 41, 42, and 43 has two circumferential dimensions along the length thereof—a greater diameter in an upper part of the head unit, and a smaller diameter in a lower part of the head unit.

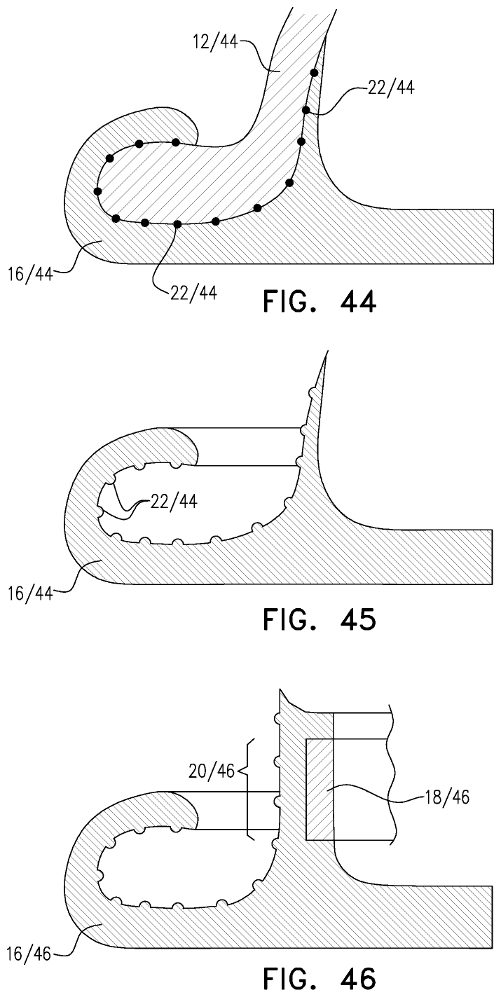

FIG. 44 is a sectional illustration of an area of a head unit at which the intermediate portion 12/44 of the head unit, which is more rigid, connects to the more flexible membrane 16/44 of the head unit. In the illustrated embodiment, the seal between the intermediate portion 12/44 and the membrane 16/44 is formed using circumferential protrusions 22/44, which are based on the principle of O-rings and which form part of membrane 16/44.

FIG. 45 is a sectional illustration of membrane 16/44 of FIG. 44, before it is attached to the intermediate portion of the head unit.

FIG. 46 is a sectional illustration of a membrane 16/46, similar to that of FIG. 45, having an inner reinforcing ring 18/46 attached thereto so as to reinforce the sealing area 20/46.

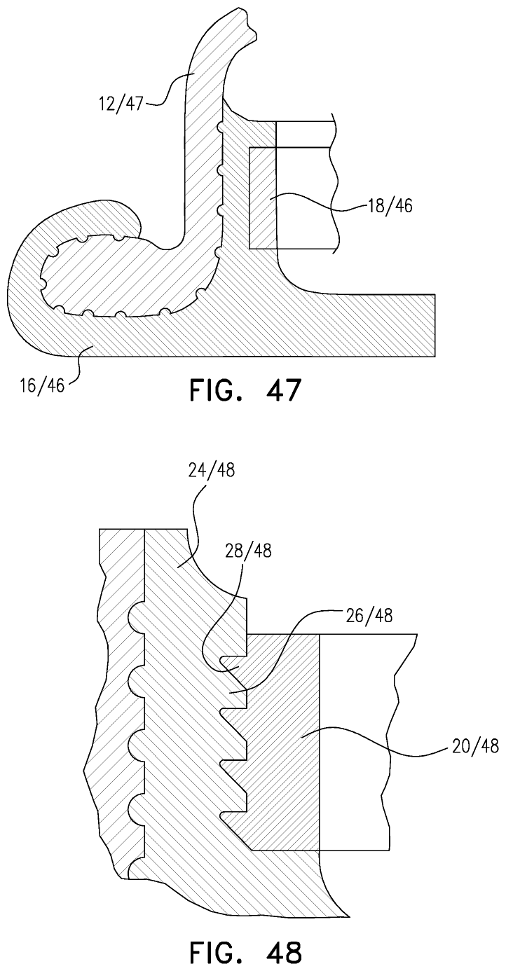

FIG. 47 is a sectional illustration of the connection area between an intermediate portion 12/47 of the head unit and membrane 16/46 of FIG. 46, which includes inner reinforcing ring 18/46.

FIG. 48 is a sectional illustration of a membrane 24/48, similar to membrane 16/46 of FIG. 46, including an inner reinforcing ring 20/48. The reinforcing ring 20/48 is locked into membrane 24/48 by a jagged edge 28/48 of the reinforcing ring, and a corresponding jagged edge 26/48 of the membrane. The main function of the reinforcing ring is to make it difficult to remove the membrane from the remainder of the head unit.

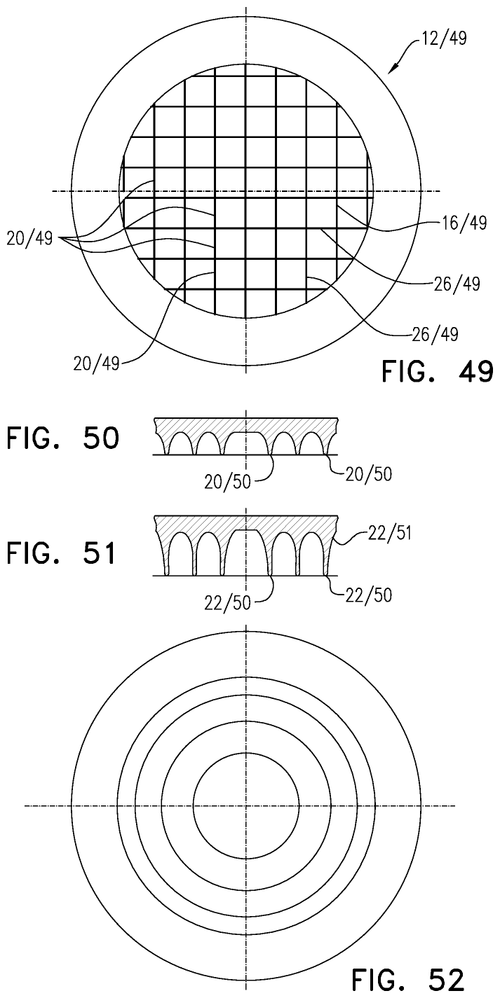

FIGS. 49, 50, 51 and 52, illustrate head units and membranes in which the engagement regions, or pressure zones, of the membrane include protrusions which are straight and perpendicular to each other, as opposed to the central and circumferential protrusions of the previous embodiments. The heights of the pressure zones, or protrusions, of the membrane, determine the flexibility at the engagement regions, where higher protrusions provide a more flexible engagement region.

FIG. 49 is a planar bottom view illustration of a head unit 12/49 having a membrane 16/49, which includes engagement regions or protrusions 20/49 which are illustrated as vertical lines and pressure zones or protrusions 26/49 which are illustrated as horizontal lines, perpendicular to protrusions 20/49, and replace the previously shown circumferential rings forming pressure zones.

FIG. 50 is a sectional illustration of the membrane of the head unit of FIG. 49, where the protrusions 20/50 have a small height, and are relatively rigid.

FIG. 51 is a sectional illustration of the membrane of the head unit of FIG. 49, where the protrusions 22/51 have a greater height, and as such are more flexible, than the protrusions 20/50 of FIG. 50.

FIG. 52 is a top view planar illustration of the head unit 12/49 of FIG. 49. This top view demonstrates that the upper portion of head unit 12/49 is equivalent to upper portions of other head units discussed hereinabove.

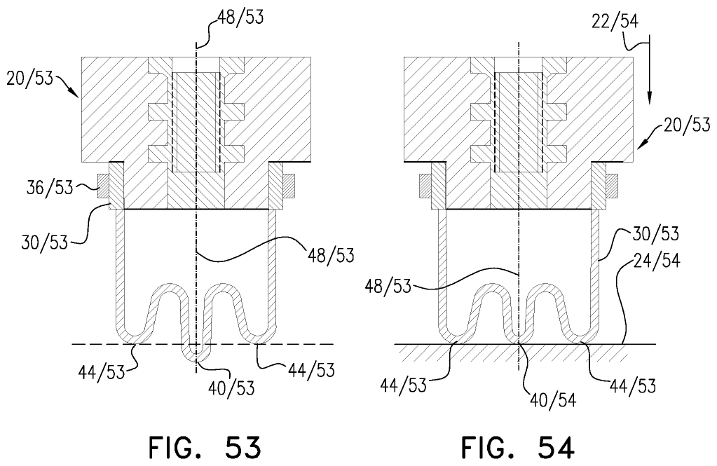

FIG. 53 is a sectional illustration of a head unit 20/53, similar to the head unit of FIG. 38, and arranged about a longitudinal axis 48/53. The head unit 20/53 is adapted for connection of a membrane 30/53 to the head by a clamping, or tightening ring 36/53, as is known in the art of mechanical engineering. The membrane includes a central protrusions 40/53 and a circumferential protrusion 44/53, where the central protrusion is higher than the circumferential protrusion. The head unit is presented with the membrane 30/53 at rest state.

FIG. 54 is a sectional illustration of the head unit 20/53 of FIG. 53, following application thereto of a force in a direction indicated by arrow 22/54, against an external surface 24/54. As seen, the protrusions 40/53 and 44/53 all engage the external surface 24/54, such that in the pressed state, the protrusions have the same height. It is appreciated that due to the difference in heights between the protrusions 40/53 and 44/53, the engagement between the protrusions and the external surface occurs at different times, such that the engagement is graded and discontinuous, as described hereinabove.

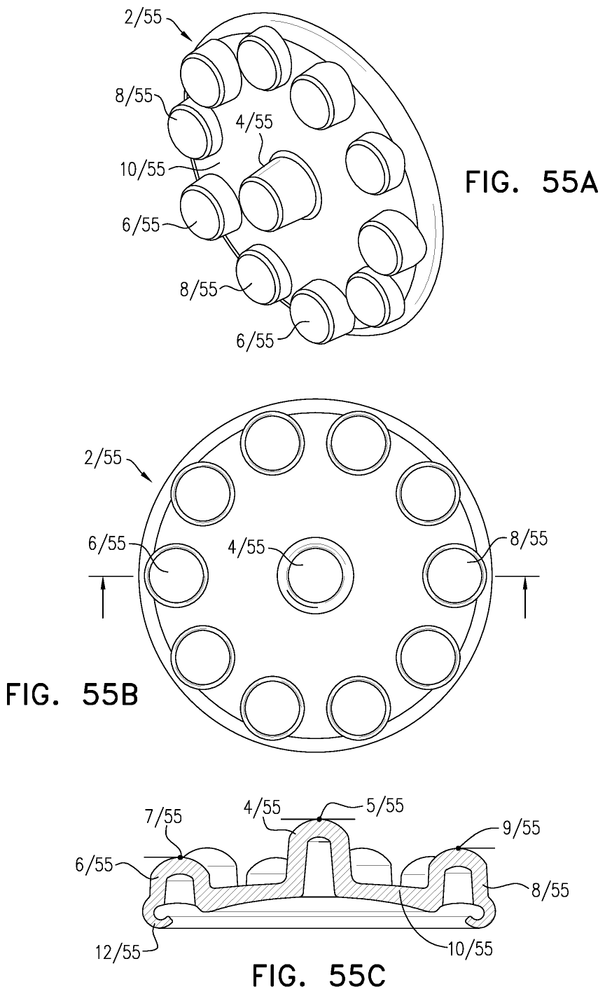

Reference is now made to FIGS. 55A, 55B, and 55C, which are, respectively, a perspective view illustration, a planar view illustration, and a sectional illustration of an embodiment of a membrane 2/55 suitable for use in a head unit according to embodiments of the present invention. For example, membrane 2/55 may be used instead of membrane 30/2A in head unit 10/2A of FIG. 2A, or instead of membrane 13/15 in head unit 10/15 of FIG. 15.

Membrane 2/55 has a first, central, protrusion 4/55 defining a first extreme point 5/55, a plurality of second protrusions 6/55 each defining a second extreme point 7/55, and a plurality of third protrusions 8/55 each defining a third extreme portion 9/55.

The first height of first protrusion 4/55 is greater than the second height of second protrusions 6/55, which in turn is greater than the third height of third protrusions 8/55. The height can be measured as defined hereinabove, or may be measured relative to a planar surface 10/55 of the membrane. Membrane 2/55 further includes a rim 12/55, suitable for wrapping onto a head unit, along the perimeter thereof, for example as described hereinabove with respect to FIG. 2A.

The second and third protrusions are arranged circumferentially about first protrusion 4/55. In the illustrated embodiment, the second and third protrusions are arranged interchangeably, and are adjacent a perimeter of membrane 2/55. Planar surface 10/55 of the membrane includes a gap which separates first protrusion 4/55 from the circumference formed by second protrusions 6/55 and third protrusions 8/55.

In the illustrated embodiment, the first, second, and third protrusions are all hollow. However, in some embodiments, at least some of the protrusions may be solid.

Because of the different heights of the first, second, and third protrusions, when force is applied to membrane 2/55 against an external surface, the first protrusion engages the surface and applies pressure thereto before the second protrusions engage the external surface. The third protrusions are last to engage the external surface, substantially as described hereinabove with respect to FIG. 2B.

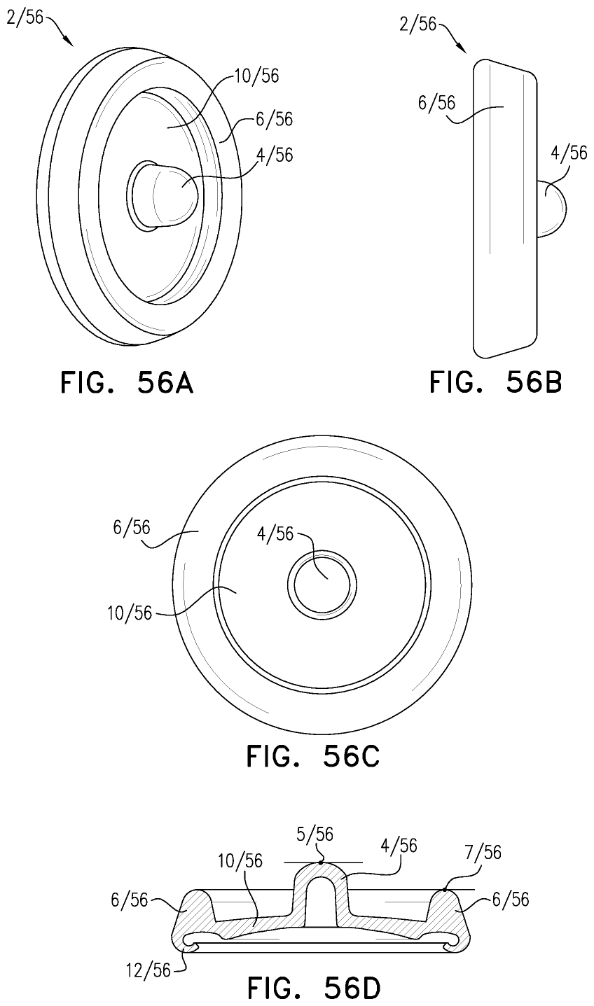

Reference is now made to FIGS. 56A, 56B, 56C, and 56D, which are, respectively, a perspective view illustration, side and bottom view planar illustrations, and a sectional illustration of an embodiment of a membrane 2/56 suitable for use in a head unit according to embodiments of the present invention. For example, membrane 2/56 may be used instead of membrane 30/2A in head unit 10/2A of FIG. 2A, or instead of membrane 13/15 in head unit 10/15 of FIG. 15.

Membrane 2/56 has a first, central, protrusion 4/56 defining a first extreme point 5/56, and a second circumferential protrusion 6/56 defining a second extreme point 7/56. The first height of first protrusion 4/56 is greater than the second height of second protrusions 6/56. In the illustrated embodiment, the second circumferential protrusion is adjacent a perimeter of membrane 2/56. A gap 10/56, in which the membrane is substantially planar, separates first protrusion 4/56 from the second protrusions 6/56. Membrane 2/56 further includes a rim 12/56, suitable for wrapping onto a head unit, along the perimeter thereof, for example as described hereinabove with respect to FIG. 2A.

In the illustrated embodiment, the first protrusion is hollow, while the second protrusion is solid. However, in some embodiments, the second protrusion may also be hollow.

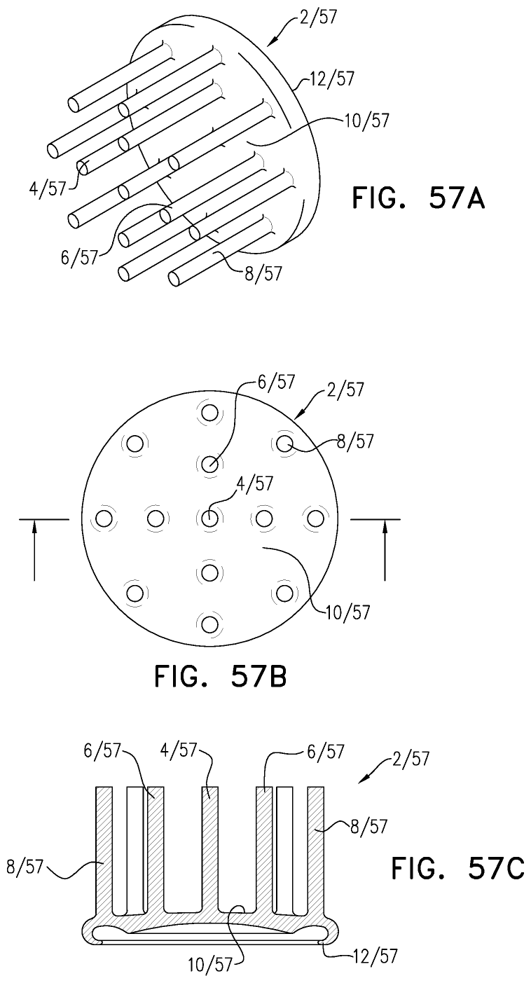

Because of the different heights of the first and second protrusions, when force is applied to membrane 2/5 against an external surface, the first protrusion engages the surface and applies pressure thereto before the second protrusion engages the external surface, substantially as described hereinabove with respect to FIG. 2B. Turning now to FIGS. 57A, 57B, and 57C, they are, respectively, a perspective view illustration, a bottom view planar illustration, and a sectional illustration of an embodiment of a membrane 2/57 suitable for use in a head unit according embodiment of the present invention. For example, membrane 2/57 may be used instead of membrane 30/2A in head unit 10/2A of FIG. 2A, or instead of membrane 13/15 in head unit 10/15 of FIG. 15.

Membrane 2/57 includes a plurality of elongate protrusions, which may be in the form of bristles, or elongated fibers, similar to those found in a pastry brush. In some embodiments, the membrane includes has a first, central, protrusion 4/57, a plurality of second protrusions 6/57 arranged circumferentially about the central protrusion, and a plurality of third protrusions 8/57 arranged circumferentially about the second protrusions. In the illustrated embodiment, the first, second, and third protrusions all have the same height. However, in some embodiments, different protrusions may have different heights, substantially as described hereinabove, for example with respect to FIGS. 55A to 55C. A plurality of gaps 10/57, in which the membrane is substantially planar, separate the first, second, and third protrusions from each other. Membrane 2/57 further includes a rim 12/57, suitable for wrapping onto a head unit, along the perimeter thereof, for example as described hereinabove with respect to FIG. 2A.

It will be appreciated that certain features of the invention, which are, for clarity, described in the context of separate embodiments, may also be provided in combination in a single embodiment. Conversely, various features of the invention, which are, for brevity, described in the context of a single embodiment, may also be provided separately or in any suitable sub-combination.

Although the invention has been described in conjunction with specific embodiments thereof, it is evident that many alternatives, modifications and variations will be apparent to those skilled in the art. Accordingly, it is intended to embrace all such alternatives, modifications and variations that fall within the spirit and broad scope of the appended claims. All publications, patents and patent applications mentioned in this specification are herein incorporated in their entirety by reference into the specification, to the same extent as if each individual publication, patent or patent application was specifically and individually indicated to be incorporated herein by reference. In addition, citation or identification of any reference in this application shall not be construed as an admission that such reference is available as prior art to the present invention.

1. A head unit, connectable to an external device, the external device including an actuator suitable for operating the head unit, the head unit comprising:
a first portion arranged about a main longitudinal axis of said head unit, said first portion having a first rigidity, said first portion including a first connection region reversibly connectable to the external device; and
a second portion having a second rigidity, smaller than said first rigidity, said second portion comprising a flexible and elastic membrane, said membrane including:
a first protrusion extending outwardly from said membrane away from said first portion and including a first extreme point associated with a first virtual tangential plane; and
a second protrusion extending outwardly from said membrane away from said first portion and including a second extreme point associated with a second virtual tangential plane; and
an intermediate portion, fixedly attached to said first portion and disposed between said first portion and said second portion, said intermediate portion having a third rigidity, different from said first rigidity and from said second rigidity,
wherein a perimeter of said membrane is attached to said intermediate portion along a perimeter of said intermediate portion,
wherein said head unit can be operated by the actuator of the external device in a periodic manner characterized by at least one amplitude and at least one frequency, and
wherein said first and second protrusions are adapted, during operation of said head unit, to engage and apply force to an external surface in a graded manner.

2. The head unit of claim 1, wherein said membrane is connected to said first portion only by said perimeter of said membrane.

3. The head unit of claim 1, wherein a first height of said first protrusion is different from a second height of said second protrusion, and wherein said graded manner of engagement and application of force is at least partially a result of said different first and second heights.

4. The head unit of claim 1, wherein said first protrusion is centered about said main longitudinal axis, and said second protrusion is circumferential about said first protrusion.

5. The head unit of claim 1 wherein said membrane is formed of a viscoelastic material or of an auxetic material.

6. The head unit of claim 1, wherein said membrane is separate from said first portion and said intermediate portion, and is reversibly attachable to said intermediate portion along said perimeter.

7. The head unit of claim 1, wherein said first portion, said intermediate portion, and said membrane are integrally formed of a single material.

8. The head unit of claim 1, wherein during application of an increasing force pushing said head unit onto said external surface, when said external surface is a flexible external surface, a contact area of said membrane with said external surface increases, resulting in a decrease of a distance between said first and second protrusions, thereby causing pinching and release of said flexible external surface between said first and second protrusions in a direction perpendicular to the main longitudinal axis.

9. The head unit of claim 1, wherein, during application of force to said membrane against a rigid external surface, a configuration of a surface of said membrane is determined by at least one of a contour of said rigid external surface, a flexibility of said membrane, and a flexibility of said rigid external surface.

10. The head unit of claim 1, wherein said membrane is asymmetrical relative to said main longitudinal axis, and has a first side having a first radius and a second side having a second radius, said second radius being larger than said first radius.

11. The head unit of claim 1, further comprising a fluid insertion portal disposed in said first portion or in said intermediate portion, said portal having an open operative orientation and a sealed operative orientation.

12. The head unit of claim 1, further comprising a reinforcing ring surrounding said first connection region.

13. The head unit of claim 1, wherein, in a rest state of the head unit and during operation of the head unit, there is a fluid filled gap between the membrane and the first portion, along the main longitudinal axis.

14. A system comprising at least two head units according to claim 1, said head units being mechanically connected to a single intermediate base, said single intermediate base including a connector adapted for connection to the external device.

15. A method for providing treatment to a treatment surface, the method comprising:
attaching a head unit according to claim 1 to an external device functioning as an actuator;
engaging said membrane of said head unit with said treatment surface, in a graded manner; and
operating said actuator such that said actuator causes percussion of said membrane against said treatment surface, wherein said application of force is periodic and is characterized by at least one amplitude and at least one frequency.

16. The head unit of claim 1, wherein said third rigidity is smaller than said second rigidity.

17. The head unit of claim 1, wherein said third rigidity is greater than said second rigidity, and smaller than said first rigidity.

18. The head unit of claim 1, wherein force of the actuator is transferred to the membrane only via said perimeter of said membrane.

19. The head unit of claim 1, wherein the force of the actuator is transferred axially to said perimeter of said membrane, and within said membrane, said force is transferred from one protrusion to the next protrusion, from the perimeter of the membrane toward the center of the membrane.

20. The head unit of claim 1, said head unit being devoid of an internal actuator.
